(19) United States
(12) Patent Application Publication
(10) Pub. No.: US 2007/0019134 A1
(43) Pub. Date: Jan. 25, 2007

(54) Polarizing film assembly, method of manufacturing the same and display device having the same

(76) Inventors: Won-Sang Park, Yongin-si (KR); Kee-Han Uh, Yongin-si (KR); Hae-Young Yun, Suwon-si (KR); Jae-Ik Lim, Chuncheon-si (KR); Seung-Kyu Lee, Yongin-si (KR); Young-Joo Chang, Suwon-si (KR); Jae-Young Lee, Yongin-si (KR); Hyung-Guel Kim, Yongin-si (KR); Sung-Eun Cha, Geoje-si (KR); Sang-Woo Kim, Suwon-si (KR)

Correspondence Address: CANTOR COLBURN, LLP, 55 GRIFFIN ROAD SOUTH, BLOOMFIELD, CT, 06002, US

(21) Appl. No.: 11/489,307

(22) Filed: Jul. 19, 2006

(30) Foreign Application Priority Data
Jul. 19, 2005 (KR) 2005-65293
Jul. 19, 2005 (KR) 2005-65299

(51) Int. Cl. G02F 1/1335

(52) U.S. Cl. 349/96

(57) ABSTRACT

A polarizing film assembly includes a polarizing film, a speaker film, a vibration improving layer, and a line member. The polarizing film includes a polarization layer transmitting a light vibrating in a polarizing direction. The speaker film is on the polarizing film to change an electric signal into a mechanical vibration to generate a sound. The vibration improving layer is interposed between the polarizing film and the speaker film to improve the mechanical vibration. The line member is electrically connected to the speaker film to transmit the electric signal. Therefore, a size and thickness of a display device are decreased while maintaining sound quality of the display device.

The present application claims priorities to Korean Patent Application No. 2005-65293, filed on Jul. 19, 2005, and Korean Patent Application No. 2005-65299, filed on Jul. 19, 2005, and all the benefits accruing therefrom under 35 U.S.C. §119, and the contents of which in their entireties are herein incorporated by reference.

### BACKGROUND OF THE INVENTION

1. Field of the Invention

The present invention relates to a polarizing film assembly, a method of manufacturing the polarizing film assembly, and a display device having the polarizing film assembly. More particularly, the present invention relates to a polarizing film assembly capable of improving a sound quality, a method of manufacturing the polarizing film assembly, and a display device having the polarizing film assembly.

2. Description of the Related Art

A display device, in general, includes a cathode ray tube (“CRT”) display device, a plasma display panel (“PDP”) display device, a liquid crystal display (“LCD”) device, an organic light-emitting display (“OLED”) device, etc. The LCD device has various characteristics such as light weight structure, small size, thin thickness, etc., and has been widely used in various fields such as mobile communication devices, monitors, television receiver sets, etc.

The display device includes a sound unit such as a magnetic speaker. The magnetic speaker includes a magnet, a coil, a diaphragm, etc., so that the display device has a large size and a heavy weight. When a size and a weight of the magnetic speaker are decreased to have a lighter weight and a smaller size, a sound quality of the magnetic speaker is deteriorated.

### BRIEF SUMMARY OF THE INVENTION

Exemplary embodiments of the present invention provide a display device including a sound unit having a small size, a light weight structure, and an improved sound quality.

Exemplary embodiments of the present invention provide a polarizing film assembly capable of improving a sound quality.

Exemplary embodiments of the present invention also provide a method of manufacturing the above-mentioned polarizing film assembly.

Exemplary embodiments of the present invention also provide a display device having the above-mentioned polarizing film assembly.

An exemplary polarizing film assembly in accordance with exemplary embodiments of the present invention includes a polarizing film, a speaker film, a vibration improving layer, and a line member. The polarizing film includes a polarization layer transmitting a light vibrating in a polarizing direction. The speaker film is on the polarizing film to change an electric signal into a mechanical vibration to generate a sound. The vibration improving layer is interposed between the polarizing film and the speaker film to improve the mechanical vibration. The line member is electrically connected to the speaker film to transmit the electric signal.

An exemplary method of manufacturing an exemplary polarizing film assembly in accordance with exemplary embodiments of the present invention is provided as follows. A primary film having a polarization layer is formed. A vibration improving layer is formed on the primary film. A speaker film is attached to the vibration improving layer to form a first film assembly. The first film assembly is cut with respect to a size of a display panel. A conductive part electrically connected to a first electrode of the speaker film is formed on an end portion of the vibration improving layer. A transparent protecting film having a transparent conductive adhesive layer is attached to a second electrode of the speaker film. A first line electrically connected to the conductive part and a second line electrically connected to the transparent conductive adhesive layer are formed.

An exemplary display device in accordance with exemplary embodiments of the present invention includes a display panel, a source driving part, a gate driving part, a sound signal outputting part, and a polarizing member. The display panel has a source line, a gate line, and a switching element electrically connected to the source and gate lines. The source driving part converts a first data signal into a second data signal of an analog type and applies the second data signal to the source line. The gate driving part applies a gate signal to the gate line. The sound signal outputting part converts a first sound signal into a second sound signal and outputs the second sound signal. The polarizing member is on the display panel and transmits a light vibrating substantially in a polarizing direction. The polarizing member generates a sound based on the second sound signal.

An exemplary display device in accordance with other exemplary embodiments of the present invention includes a display assembly, a speaker film, and a vibration improving layer. The display assembly includes a backlight assembly, a panel assembly, and a receiving container. The backlight assembly generates a light. The panel assembly displays images using the light. The receiving container receives the backlight assembly and the panel assembly. The speaker film is on the display assembly to generate a sound. The vibration improving layer is interposed between the display assembly and the speaker film.

An exemplary display device in accordance with still other exemplary embodiments of the present invention includes a display assembly and a speaker film. The display assembly includes a backlight assembly, a panel assembly, and a receiving container. The backlight assembly generates a light. The panel assembly displays images using the light. The receiving container receives the backlight assembly and the panel assembly. The speaker film is on a surface of the display assembly. The speaker film includes a vibration improving layer interposed between the speaker film and the display assembly.

According to exemplary embodiments of the present invention, the display device having the speaker film generates the sound. Therefore, the size and thickness of the display device may be decreased.

### BRIEF DESCRIPTION OF THE DRAWINGS

The above and other advantages of the present invention will become more apparent by describing exemplary embodiments thereof with reference to the accompanying drawings, in which:

FIG. 1 is a cross-sectional view illustrating an exemplary polarizing film assembly in accordance with an exemplary embodiment of the present invention;

FIG. 2 is a cross-sectional view illustrating an exemplary polarizing film assembly in accordance with another exemplary embodiment of the present invention;

FIGS. 3A to 3E are cross-sectional views illustrating an exemplary method of manufacturing the exemplary polarizing film assembly shown in FIG. 1;

FIGS. 4A and 4B are cross-sectional views illustrating an exemplary process of forming an exemplary vibration improving layer shown in FIG. 1;

FIGS. 5A and 5B are cross-sectional views illustrating an exemplary process of forming an exemplary vibration improving layer in accordance with another exemplary embodiment of the present invention;

FIGS. 6A and 6B are cross-sectional views illustrating an exemplary process of forming an exemplary vibration improving layer in accordance with another exemplary embodiment of the present invention;

FIG. 7 is a cross-sectional view illustrating an exemplary vibration improving layer in accordance with another exemplary embodiment of the present invention;

FIG. 8 is a plan view illustrating an exemplary display panel module in accordance with another exemplary embodiment of the present invention;

FIG. 9 is a cross-sectional view taken along line I-I′ shown in FIG. 8;

FIGS. 10A and 10B are cross-sectional views illustrating a light passing through the exemplary display panel module shown in FIG. 8;

FIG. 11 is a plan view illustrating an exemplary display panel module in accordance with another exemplary embodiment of the present invention;

FIG. 12 is a cross-sectional view taken along line II-II′ shown in FIG. 11;

FIG. 13 is a block diagram illustrating an exemplary display device in accordance with another exemplary embodiment of the present invention;

FIG. 14 is a block diagram illustrating an exemplary sound signal outputting part shown in FIG. 13;

FIG. 15 is an exploded perspective view illustrating an exemplary display device in accordance with another exemplary embodiment of the present invention;

FIG. 16 is a cross-sectional view illustrating the exemplary display device shown in FIG. 15;

FIG. 17 is a block diagram illustrating an operation of an exemplary speaker film shown in FIG. 15;

FIGS. 18A and 18B are cross-sectional views illustrating an exemplary process of forming an exemplary vibration improving layer shown in FIG. 15;

FIGS. 19A and 19B are cross-sectional views illustrating an exemplary process of forming an exemplary vibration improving layer in accordance with another exemplary embodiment of the present invention;

FIG. 20 is a cross-sectional view illustrating an exemplary method of forming an exemplary vibration improving layer in accordance with another exemplary embodiment of the present invention;

FIG. 21 is a cross-sectional view illustrating an exemplary display device in accordance with another exemplary embodiment of the present invention; and

FIG. 22 is an exploded perspective view illustrating an exemplary display device in accordance with another exemplary embodiment of the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described with reference to the accompanying drawings.

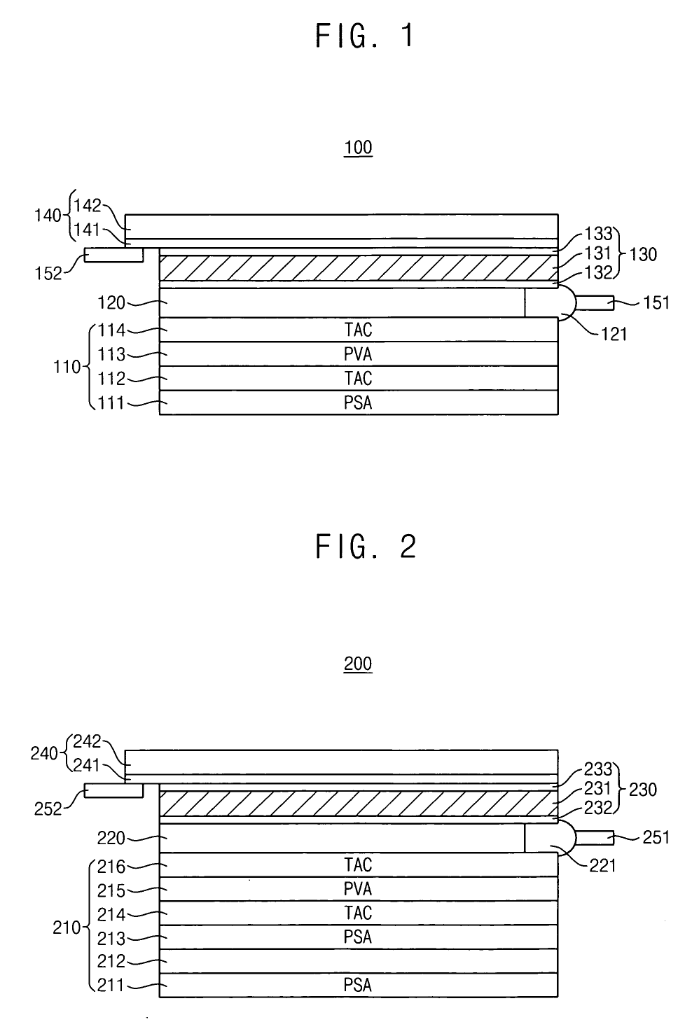

FIG. 1 is a cross-sectional view illustrating an exemplary polarizing film assembly in accordance with an exemplary embodiment of the present invention.

Referring to FIG. 1, the polarizing film assembly 100 includes a transmissive polarizing film 110, a vibration improving (or active) layer 120, a speaker film 130, and a protecting film 140 sequentially stacked, and line members 151 and 152.

The transmissive polarizing film 110 includes a pressure sensitive adhesive (“PSA”) layer 111, a first protection layer 112, a polarization layer 113, and a second protection layer 114 sequentially stacked in the transmissive polarizing film 110, with the PSA layer 111 disposed on an outer surface of the polarizing film assembly 100 and the second protection layer 114 disposed adjacent the vibration improving layer 120. Each of the first and second protection layers 112 and 114 may include triacetylcellulose (“TAC”). The polarization layer 113 may include polyvinylalcohol (“PVA”).

The PSA layer 111 includes an adhesive material, and is attached in response to an externally provided pressure. Examples of the adhesive material that can be used for the PSA layer 111 include, but are not limited to, an acrylic based resin, a rubber based resin, etc. These can be used alone or in a combination thereof. The PSA layer 111 may further include a plurality of particles to control a refractive index of the PSA layer 111. Examples of the particles that can be used for controlling the refractive index of the PSA layer 111 include, but are not limited to, zirconium, quartz, etc. These can be used alone or in a combination thereof.

The first protection layer 112 is interposed between the PSA layer 111 and the polarization layer 113. The second protection layer 114 is on the polarization layer 113 opposite to the first protection layer 112. Each of the first and second protection layers 112 and 114 includes a transparent material. Each of the first and second protection layers 112 and 114 may include an acetate based resin such as TAC. In FIG. 1, each of the first and second protection layers 112 and 114 includes a TAC film having a saponified surface that is saponified by alkaline ions.

The polarization layer 113 transmits a component of a light vibrating parallel to the polarizing direction, and blocks a component of the light vibrating perpendicular to the polarizing direction.

The vibration improving layer 120 is formed on the second protection layer 114. In FIG. 1, an upper portion of the second protection layer 114 is surface-treated to form the vibration improving layer 120, and the vibration improving layer 120 improves a vibration of the speaker film 130. The vibration improving layer 120 may include an air layer. Alternatively, the vibration improving layer 120 may include an elastic material. A conductive part 121 is formed on an end portion of the vibration improving layer 120 and is electrically connected to a first electrode 132 of the speaker film 130.

The speaker film 130 includes a piezoelectric layer 131 sandwiched between the first electrode 132 and a second electrode 133. The first electrode 132 is formed on a first surface of the piezoelectric layer 131, where the first electrode 132 is disposed between the vibration improving layer 120 and the piezoelectric layer 131. The second electrode 133 is formed on a second surface of the piezoelectric layer 131, opposite the first surface, where the second electrode 133 is disposed between the protecting film 140 and the piezoelectric layer 131. The first electrode 132 may be substantially plate-shaped and may cover substantially an entire surface area of the first surface of the piezoelectric layer 131. Likewise, the second electrode 133 may be substantially plate-shaped and may cover substantially an entire surface area of the second surface of the piezoelectric layer 131.

The piezoelectric layer 131 changes an electric sound signal into a mechanical vibration to generate a sound. In FIG. 1, the piezoelectric layer 131 may include polyvinylidenfluoride (“PVDF”) or derivatives thereof. These can be used alone or in a combination thereof.

Alternatively, the piezoelectric layer 131 may include a mixture of polyvinulidenfluoride (“PVDF”) and hexafluoropropylene (“HFP”), a copolymer of vinylidenefluoride/trifluorethylene (“VDF/TrFE”), etc. When the electric sound signal is applied to the first and second electrodes 132 and 133, the piezoelectric layer 131 disposed between the first and second electrodes 132 and 133 vibrates to generate the sound.

A transparent conductive material may be deposited on the first and second surfaces of the piezoelectric layer 131 to form the first and second electrodes 132 and 133. Examples of the transparent conductive material that can be used for the first and second electrodes 132 and 133 include, but are not limited to, indium tin oxide (“ITO”), tin oxide (“TO”), indium zinc oxide (“IZO”), zinc oxide (“ZO”), indium tin zinc oxide (“ITZO”), amorphous indium tin oxide (“a-ITO”), etc. These can be used alone or in a combination thereof.

The protecting film 140 includes a conductive adhesive layer 141 and a protection layer 142. The conductive adhesive layer 141 is formed on a rear surface of the protection layer 142. The protecting film 140 is attached to the second electrode 133 of the speaker film 130 through the conductive adhesive layer 141. The protecting film 140 is protruded from an end portion of the speaker film 130. That is, the protecting film 140 may have a greater surface area than a surface area of the second electrode 133.

The line members 151 and 152 include a first line 151 and a second line 152. The first line 151 is electrically connected to the first electrode 132 of the speaker film 130. The second line 152 is electrically connected to the second electrode 133 of the speaker film 130.

The first line 151 is electrically connected to the conductive part 121 that makes contact with the first electrode 132. The second line 152 is electrically connected to the conductive adhesive layer 141 that makes contact with the second electrode 133. The electric sound signal is applied to the first and second electrodes 132 and 133 of the speaker film 130 through the first and second lines 151 and 152.

FIG. 2 is a cross-sectional view illustrating an exemplary polarizing film assembly in accordance with another exemplary embodiment of the present invention.

Referring to FIG. 2, the polarizing film assembly 200 includes a reflective-transmissive polarization film 210, a vibration improving (or active) layer 220, a speaker film 230, and a protecting film 240 sequentially stacked, and line members 251 and 252.

The reflective-transmissive polarizing film 210 includes a first PSA layer 211, a phase difference layer 212, a second PSA layer 213, a first protection layer 214, a polarization layer 215, and a second protection layer 216 sequentially stacked in the reflective-transmissive polarizing film 210. Each of the first and second protection layers 214 and 216 may include, but is not limited to, TAC. The polarization layer 215 may include, but is not limited to, PVA.

Each of the first and second PSA layers 211 and 213 includes an adhesive material, and is attached in response to an externally provided pressure. Examples of the adhesive material that can be used for the first and second PSA layers 211 and 213 include, but are not limited to, an acrylic based resin, a rubber based resin, etc. These can be used alone or in a combination thereof. Each of the first and second PSA layers 211 and 213 may further include a plurality of particles to control a refractive index of each of the first and second PSA layers 211 and 213. Examples of the particles that can be used for controlling the refractive index of each of the first and second PSA layers 211 and 213 include, but are not limited to, zirconium, quartz, etc. These can be used alone or in a combination thereof.

The first protection layer 214 is interposed between the first PSA layer 213 and the polarization layer 215. The second protection layer 216 is on the polarization layer 215 opposite to the first protection layer 214. Each of the first and second protection layers 214 and 216 includes a transparent material. Each of the first and second protection layers 214 and 216 may include an acetate based resin such as, but not limited to, TAC.

The polarization layer 215 transmits a component of a light vibrating parallel to a polarizing direction, and blocks a component of the light vibrating perpendicular to the polarizing direction.

The phase difference layer 212 changes a phase of the light. For example, the phase difference layer 212 may change a linearly polarized light into a right or left circularly polarized light. Alternatively, the phase difference layer 212 may also change the right or left circularly polarized light into the linearly polarized light that vibrates in about 45° or about 135° with respect to a longitudinal direction of the polarizing film assembly 200.

The vibration improving layer 220 is formed on the second protection layer 216. In FIG. 2, an upper portion of the second protection layer 216 is surface-treated to form the vibration improving layer 220, and the vibration improving layer 220 improves a vibration of the speaker film 230. The vibration improving layer 220 may include an air layer. Alternatively, the vibration improving layer 220 may include an elastic material. A conductive part 221 is formed on an end portion of the vibration improving layer 220 and is electrically connected to a first electrode 232 of the speaker film 230.

The speaker film 230 includes a piezoelectric layer 231 disposed between the first electrode 232 and a second electrode 233. The first electrode 232 is formed on a first surface of the piezoelectric layer 231, where the first electrode 232 is disposed between the vibration improving layer 220 and the piezoelectric layer 231. The second electrode 233 is formed on a second surface of the piezoelectric layer 231, opposite the first surface, where the second electrode 233 is disposed between the protecting film 240 and the piezoelectric layer 231. The first electrode 232 may be substantially plate-shaped and may cover substantially an entire surface area of the first surface of the piezoelectric layer 231. Likewise, the second electrode 233 may be substantially plate-shaped and may cover substantially an entire surface area of the second surface of the piezoelectric layer 231.

The piezoelectric layer 231 changes an electric sound signal into a mechanical vibration to generate a sound. In FIG. 2, the piezoelectric layer 231 may include, but is not limited to, PVDF or derivatives thereof. These can be used alone or in a combination thereof.

When the electric sound signal is applied to the first and second electrodes 232 and 233, the piezoelectric layer 231 vibrates to generate the sound.

A transparent conductive material may be deposited on the first and second surfaces of the piezoelectric layer 231 to form the first and second electrodes 232 and 233. Examples of the transparent conductive material that can be used for the first and second electrodes 232 and 233 include, but are not limited to, ITO, TO, IZO, ZO, ITZO, a-ITO, etc. These can be used alone or in a combination thereof. A conductive adhesive layer 241 is formed on a rear surface of the protection layer 242. The protecting film 240 is attached to the second electrode 233 of the speaker film 230 through the conductive adhesive layer 241. The protecting film 240 is protruded from an end portion of the speaker film 230. That is, the protecting film 240 may have a greater surface area than a surface area of the second electrode 233.

The line members 251 and 252 include a first line 251 and a second line 252. The first line 251 is electrically connected to the first electrode 232 of the speaker film 230. The second line 252 is electrically connected to the second electrode 233 of the speaker film 230.

The first line 251 is electrically connected to the conductive part 221 that makes contact with the first electrode 232. The second line 252 is electrically connected to the conductive adhesive layer 241 that makes contact with the second electrode 233. An electric sound signal is applied to the first and second electrodes 232 and 233 of the speaker film 230 through the first and second lines 251 and 252.

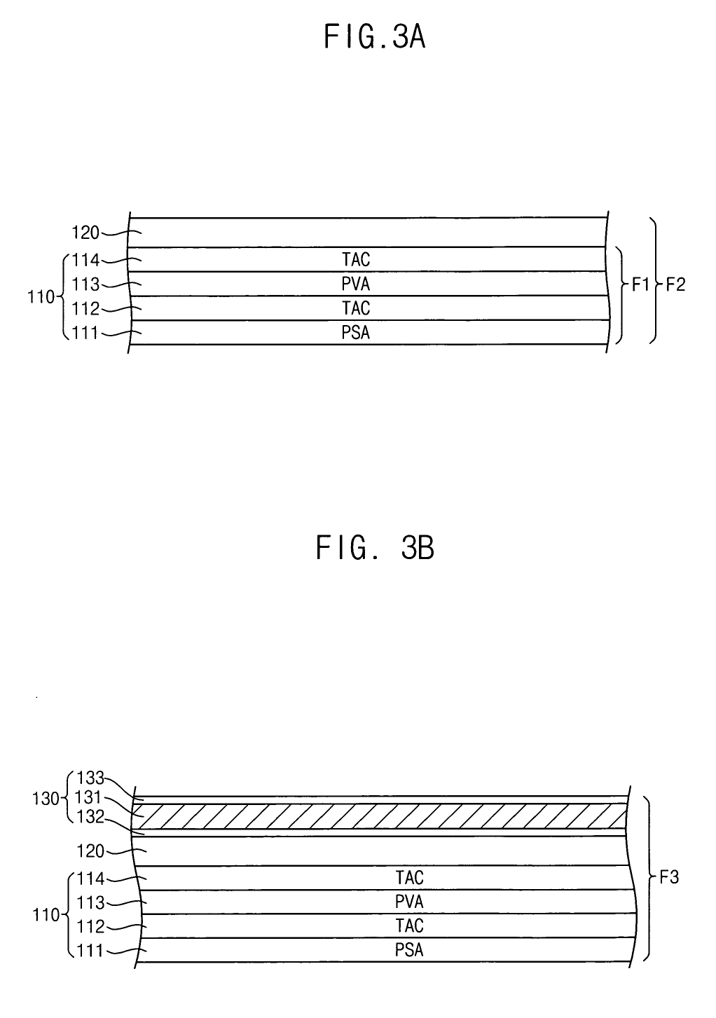

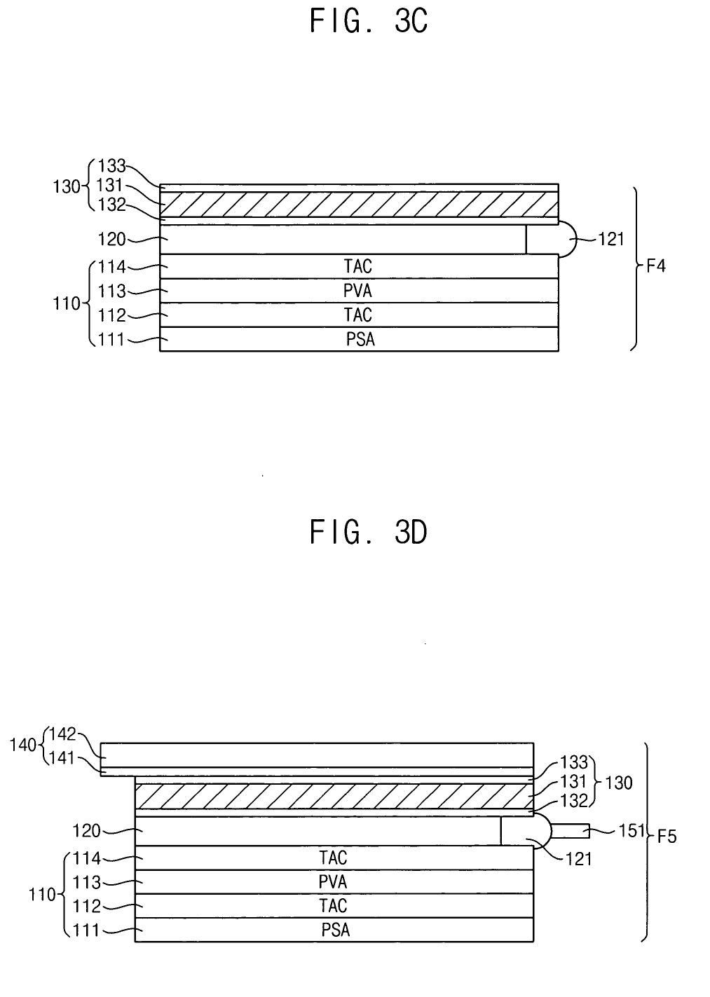

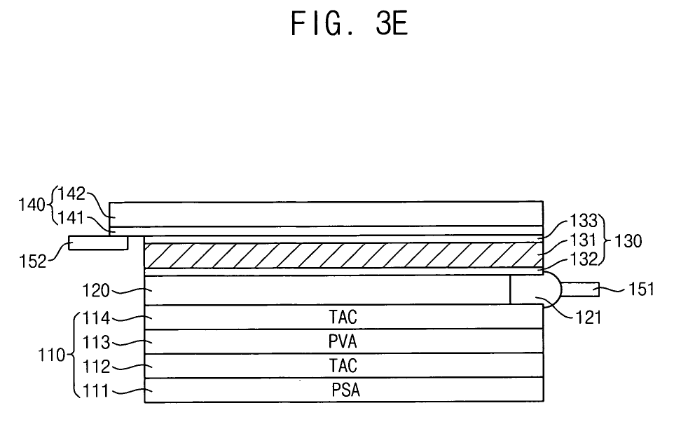

FIGS. 3A to 3E are cross-sectional views illustrating an exemplary method of manufacturing the exemplary polarizing film assembly shown in FIG. 1.

Referring to FIGS. 1 and 3A, a rolled PSA film for forming the PSA layer 111, a rolled first protecting film for forming the first protection layer 112, a rolled polarization film for forming the polarization layer 113, and a rolled second protecting film for forming the second protection layer 114 are laminated using a laminating unit to form a first polarizing member F1.

The upper portion of the second protection layer 114 is surface-treated to form the vibration improving layer 120, thereby forming a second polarizing member F2.

The vibration improving layer 120 increases an amount of a vibration of the speaker film 130 on the transmissive polarizing film 110. For example, the vibration improving layer 120 may be an embossing layer, an air layer, a bubble layer, etc. Alternatively, the vibration improving layer 120 may include a transparent elastic material having a spacer.

Referring to FIGS. 3B and 3C, the speaker film 130 is attached to the second polarizing member F2 and on the vibration improving layer 120 to form a third polarizing member F3. The speaker film 130 includes the piezoelectric layer 131, the first electrode 132 that is formed on the first surface of the piezoelectric layer 131 and the second electrode 133 that is formed on the second surface of the piezoelectric layer 131.

The third polarizing member F3 having the speaker film 130 attached to the polarizing film 110 and the vibration improving layer 120 is cut with respect to a size of a display panel to form a fourth polarizing member F4.

A conductive material having fluidity is injected into a space on an end portion of the vibration improving layer 120 to form the conductive part 121. The conductive part 121 makes contact with the first electrode 132, and is electrically connected to the first electrode 132.

Referring to FIGS. 3D and 3E, the protecting film 140 having the conductive adhesive layer 141 and the protection layer 142 is attached to the fourth polarizing member F4 on the second electrode 133 of the speaker film 130 to form a fifth polarizing member F5.

The conductive adhesive layer 141 makes contact with the second electrode 133 of the speaker film 130. The protecting film 140 is protruded from an end portion of the speaker film 130, opposite the end portion of the speaker film 130 on which the conductive part 121 contacts.

The first line 151 is formed on the conductive part 121 that is on the first end portion of the speaker film 130, and the second line 152 is formed on the second end portion of the speaker film 130.

The first and second lines 151 and 152 function as input terminals of the speaker film 130. The first and second lines 151 and 152 are electrically connected to the first and second electrodes 132 and 133, respectively.

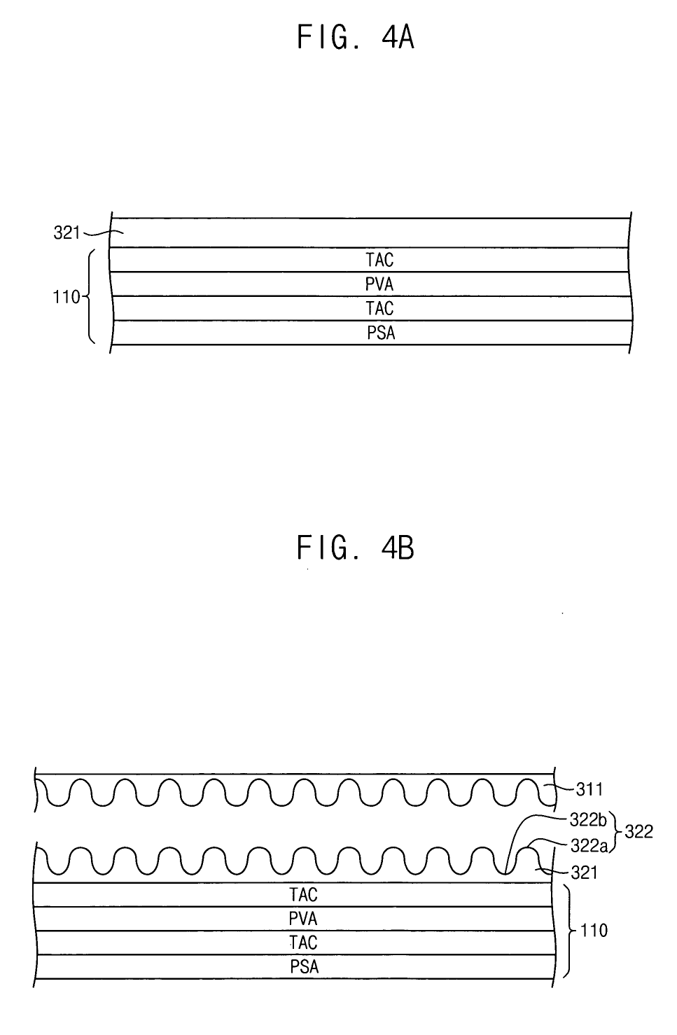

FIGS. 4A and 4B are cross-sectional views illustrating an exemplary process of forming an exemplary vibration improving layer shown in FIG. 1.

Referring to FIGS. 1, 4A and 4B, a synthetic resin layer 321 is coated on the second protection layer 114 of the transmissive polarizing film 110. The synthetic resin layer 321 is pressed using a mold 311 having an embossing pattern.

Therefore, the vibration improving layer 322 having the embossing pattern is formed. The vibration improving layer 322 includes a plurality of convexes 322a and a plurality of concaves 322b. An air layer is formed in the concaves 322b.

The synthetic resin layer 321 includes an acryl based ultraviolet curable resin. Examples of the acryl based ultraviolet curable resin that can be used for the synthetic resin layer 321 include, but are not limited to, a photopolymerization monomer or oligomer having an acrylate, an epoxyacrylate, polyester acrylate, urethane acrylate, etc., acetophenone, benzophenone, thioxanthone, etc. These can be used alone or in a combination thereof.

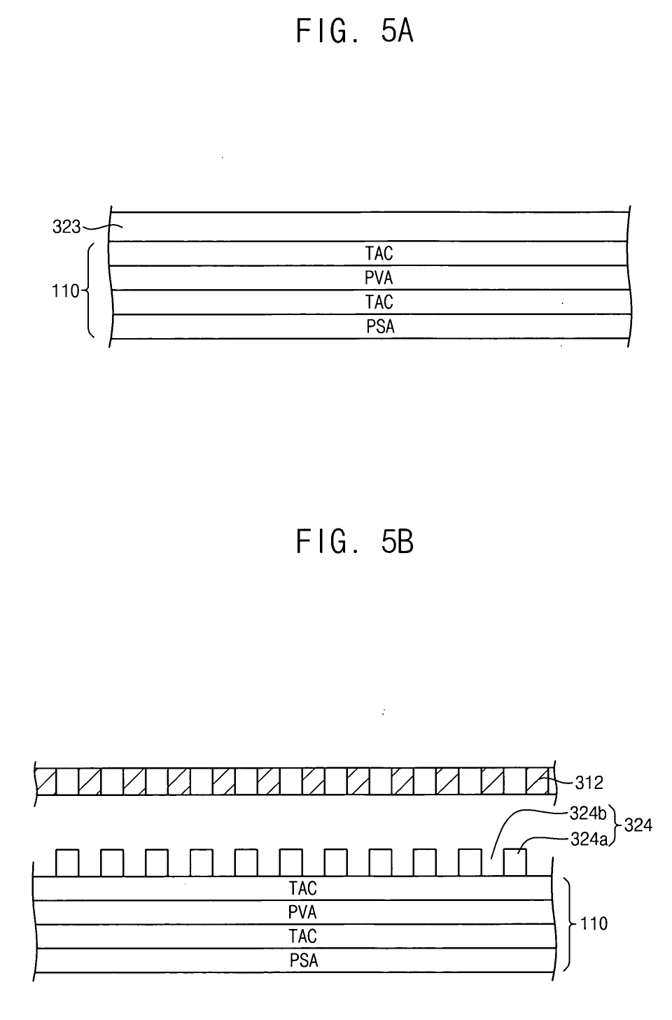

FIGS. 5A and 5B are cross-sectional views illustrating an exemplary process of forming an exemplary vibration improving layer in accordance with another exemplary embodiment of the present invention.

Referring to FIGS. 1, 5A and 5B, a synthetic resin layer 323 is coated on the second protection layer 114 of the transmissive polarizing film 110. The synthetic resin layer 323 is patterned using a mask 312 having opening patterns to form a vibration improving layer 324.

The vibration improving layer 324 includes a plurality of convexes 324a and a plurality of concaves 324b. An air layer is formed in the concaves 324b.

The synthetic resin layer 323 includes an acryl based ultraviolet curable resin. Examples of the acryl based ultraviolet curable resin that can be used for the synthetic resin layer 323 include, but are not limited to, a photopolymerization monomer or oligomer having an acrylate, an epoxyacrylate, polyester acrylate, urethane acrylate, etc., acetophenone, benzophenone, thioxanthone, etc. These can be used alone or in a combination thereof.

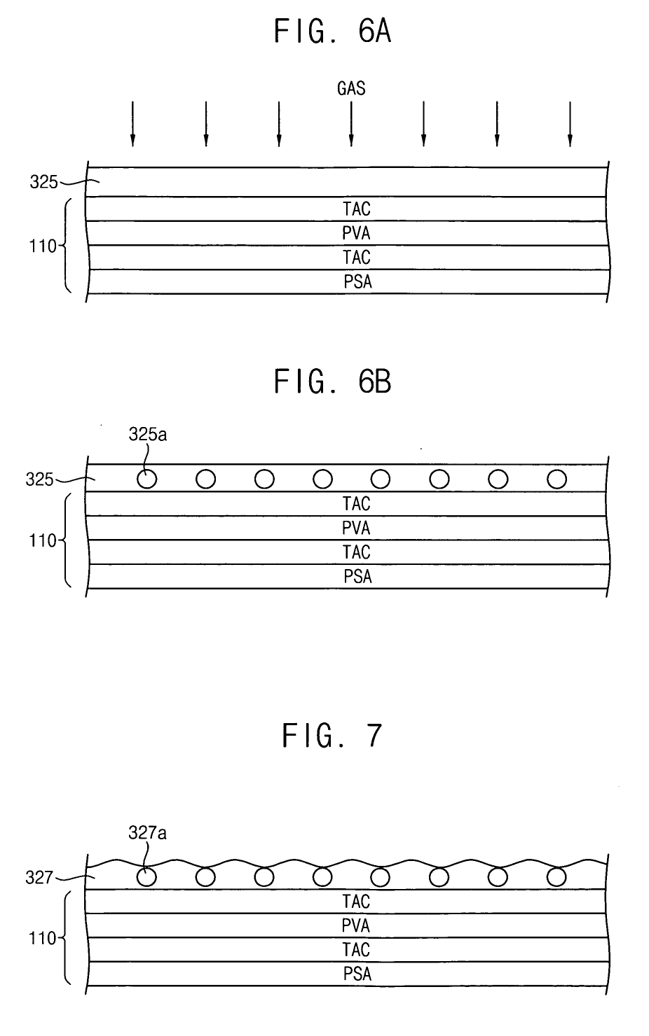

FIGS. 6A and 6B are cross-sectional views illustrating an exemplary process of forming an exemplary vibration improving layer in accordance with another exemplary embodiment of the present invention.

Referring to FIGS. 1, 6A and 6B, a synthetic resin layer 325 is coated on the second protection layer 114 of the transmissive polarizing film 110. The synthetic resin layer 325 includes a foaming agent that has an inert gas under high pressure. Examples of the inert gas that can be used for the foaming agent include, but are not limited to, carbon dioxide, nitrogen, etc. These can be used alone or in a combination thereof. The synthetic resin layer 325 having the foaming agent is then decompressed and heated to form bubbles 325a in the synthetic resin layer 325.

Therefore, the synthetic resin layer 325 is formed as a vibration improving layer having the bubbles 325a on the second protection layer 114.

FIG. 7 is a cross-sectional view illustrating an exemplary vibration improving layer in accordance with another exemplary embodiment of the present invention.

Referring to FIG. 7, a synthetic resin layer 327 is coated on the second protection layer 114 of the transmissive polarizing film 110. The synthetic resin layer 327 includes a plurality of spacers 327a. For example, the synthetic resin layer 327 includes transparent elastic adhesives.

The spacers 327a maintain a distance between a speaker film 130 and the transmissive polarizing film 110. The transparent elastic adhesives of the synthetic resin layer 327 increase a vibration of the speaker film 130. The transparent elastic adhesives of the synthetic resin layer 327 may function substantially the same as the air layer between the speaker film 130 and the transmissive polarizing film 110, as described above in previous exemplary embodiments.

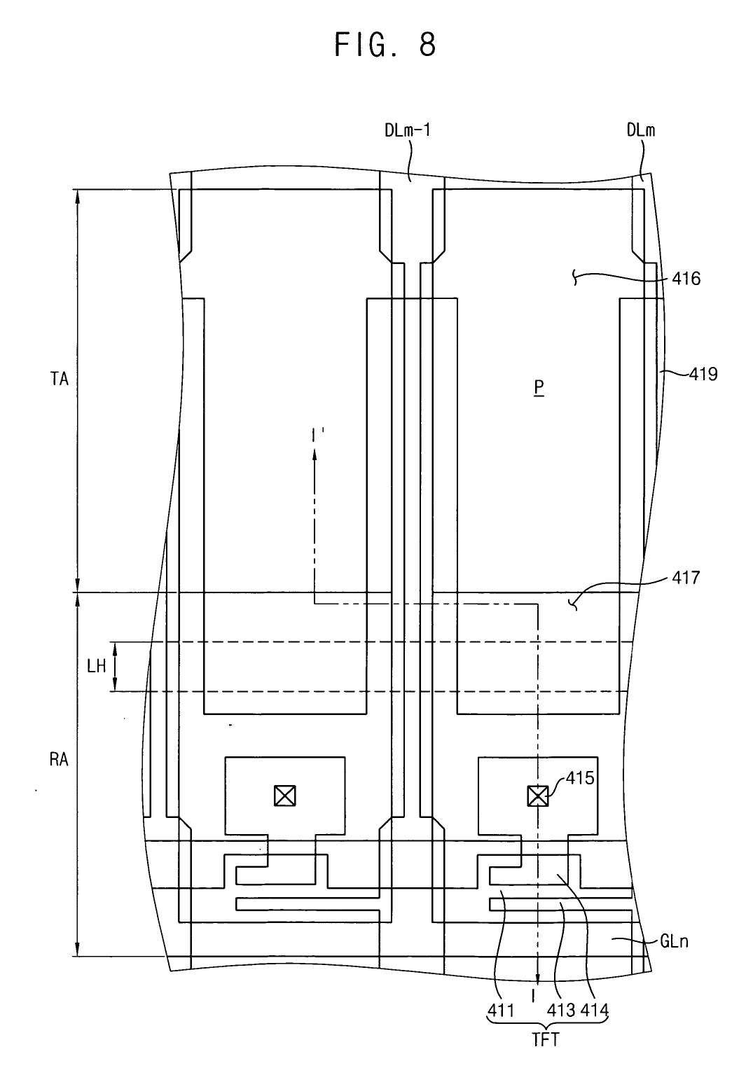

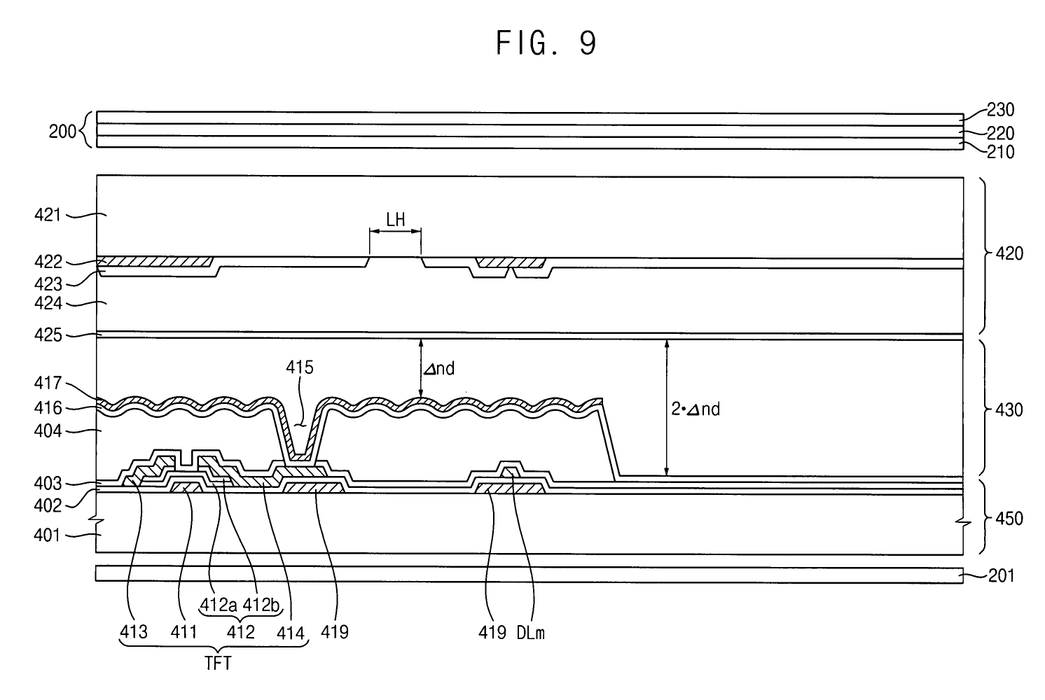

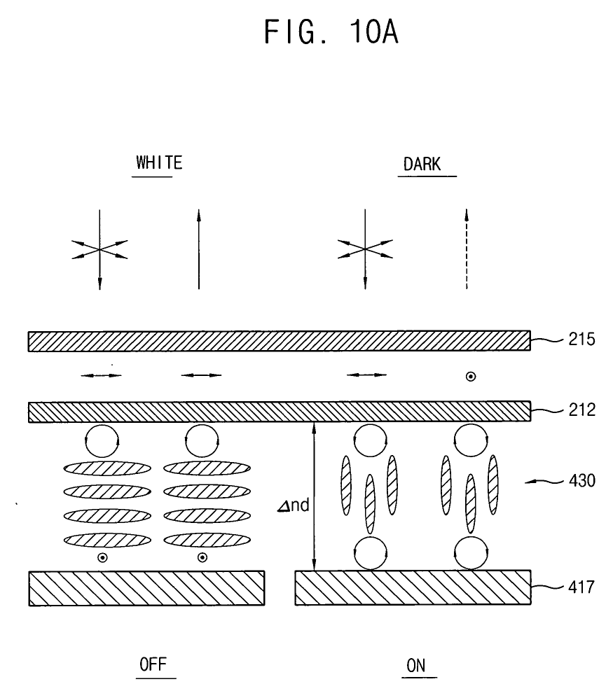

FIG. 8 is a plan view illustrating an exemplary display panel module in accordance with another exemplary embodiment of the present invention. FIG. 9 is a cross-sectional view taken along line I-I′ shown in FIG. 8.

Referring to FIGS. 8 and 9, the display panel module includes a liquid crystal display (“LCD”) panel, a polarizing film assembly 200 serving as an upper polarizing member, and a lower polarizing member 201. The polarizing film assembly 200 serving as the upper polarizing member is on an upper surface of the LCD panel. The lower polarizing member 201 is on a lower surface of the LCD panel.

The LCD panel includes an array substrate 450, an opposite substrate 420, and a liquid crystal layer 430. The opposite substrate 420 faces the array substrate 450. The liquid crystal layer 430 is interposed between the array substrate 450 and the opposite substrate 420.

The array substrate 450 includes a first base substrate 401 and a plurality of gate lines Gn, a plurality of source lines DLm−1, DLm and DLm+1, a plurality of storage common lines 419, and a plurality of pixels P formed on the first base substrate 401. Each of the pixels P includes a switching element TFT, such as a thin film transistor, a pixel electrode 416, and a reflection electrode 417. The pixel electrode 416 is electrically connected to the switching element TFT. The reflection electrode 417 is on a portion of the pixel electrode 416 defining a reflection region RA. A transmission region TA is defined by a portion of the pixel electrode 416 not having the reflection electrode 417 thereon.

The switching element TFT includes a gate electrode 411, a source electrode 413, and a drain electrode 414. The gate electrode 411 is electrically connected to one of the gate lines GLn. The source electrode 413 is electrically connected to one of the data lines DLm+1. The drain electrode 414 is electrically connected to the pixel electrode 416.

A gate insulating layer 402 is formed on the gate line GLn, the gate electrode 411, and the storage common line 419. The gate insulating layer 402 may be further formed on exposed portions of the first base substrate 401. A channel layer 412 is formed on the gate insulating layer 402 between the gate electrode 411 and the source and drain electrodes 413 and 414 which are separated from each other. The channel layer 412 includes an amorphous silicon layer 412a and an N+ amorphous silicon layer 412b. Impurities are implanted on an upper portion of the amorphous silicon layer 412a to form the N+ amorphous silicon layer 412b.

A passivation layer 403 is formed on the data lines DLm+1, the source electrode 413, and the drain electrode 414. The passivation layer 403 may be further formed on exposed portions of the gate insulating layer 402, as well as on the amorphous silicon layer 412a within a channel region defined between the source electrode 413 and the drain electrode 414 and exposed through an opening created in the N+ amorphous silicon layer 412b. An organic layer 404 is formed on the passivation layer 403 corresponding to the reflection region RA. A surface of the organic layer 404 is patterned to have an embossed shape, so that the upper portion of the organic layer 404 may function as micro reflection lenses to diffuse an externally provided light. Alternatively, the organic layer 404 may also have a flat surface.

The passivation layer 403 and the organic layer 404 on the drain electrode 414 are partially removed to form a contact hole 415 through which the drain electrode 414 is partially exposed.

The pixel electrode 416 is electrically connected to the drain electrode 414 through the contact hole 415. The pixel electrode 416 includes a transparent conductive material. Examples of the transparent conductive material that can be used for the pixel electrode 416 include, but are not limited to, ITO, TO, IZO, ZO, ITZO, a-ITO, etc. These can be used alone or in a combination thereof.

The reflection electrode 417 is partially formed on the pixel electrode 416 to define the reflection region RA. The transmission region TA is defined by the portion of the pixel electrode 416 not having the reflection electrode 417 thereon. The reflection electrode 417 includes a highly reflective material. Examples of the highly reflective material that can be used for the reflection electrode 417 include, but are not limited to, aluminum, aluminum-neodymium alloy, silver, silver-molybdenum alloy etc. These can be used alone or in a combination thereof.

The opposite substrate 420 includes a second base substrate 421.

A black matrix 422 is formed on the second base substrate 421. The black matrix 422 corresponds to the source lines DLm−1, DLm and DLm+1 and the gate lines GLn of the array substrate 450.

When the storage common line 419 formed under the source lines DLm−1, DLm and DLm+1 has a size sufficient to cover each of the source lines DLm−1, DLm and DLm+1, the black matrix 422 may only cover the gate lines GLm so that the storage common line 419 may function as the black matrix 422.

A color filter layer 423 is formed on the second base substrate 421 having the black matrix 422. The color filter layer 423 may include, but is not limited to, red, green, and blue color filters.

A light hole LH may be formed on a portion of the color filter layer 423 corresponding to a portion of the reflection region RA. A portion of the color filter layer 423 is partially removed to form the light hole LH. An overcoating layer 424 is formed on the color filter layer 423. A common electrode layer 425 is formed on the overcoating layer 424.

The liquid crystal layer 430 includes a first cell gap 2Δnd corresponding to the transmission region TA and a second cell gap Δnd corresponding to the reflection region RA so that the reflection region RA has substantially the same light path as the transmission region TA, wherein Δn and d represent an anisotropy and a thickness of the liquid crystal layer 430, respectively. In FIGS. 8 and 9, a thickness of the organic layer 404 is changed to control the cell gaps. For example, the thickness of the organic layer 404 is greater in the reflection region RA than it is in the transmission region TA. As illustrated in FIG. 9, the organic layer 404 may be excluded from the transmission region TA. Alternatively, a thickness of the overcoating layer 424 may be changed to control the cell gaps.

The polarizing film assembly 200 forming an upper polarizing member of FIGS. 8 and 9 is substantially the same as in FIG. 2, and reference should be made to FIG. 2 for a more detailed view of the upper polarizing member of the display panel module of FIGS. 8 and 9. Thus, the same reference numerals will be used to refer to the same or like parts as those described in FIG. 2 and any further explanation concerning the above elements will be omitted.

Referring again to FIG. 2, the polarizing film assembly 200 includes a reflective-transmissive polarization film 210, a vibration improving layer 220, a speaker film 230, a protecting film 240 and line members 251 and 252. The reflective-transmissive polarizing film 210, including a phase difference layer 212, changes a phase of the light. For example, the reflective-transmissive polarizing film 210 may change a linearly polarized light into a right or left circularly polarized light. Alternatively, the reflective-transmissive polarizing film 210 may also change the right or left circularly polarized light into the linearly polarized light.

The line members 251 and 252 are electrically connected between the speaker film 230 and a sound signal outputting part (not shown) to transmit an electric sound signal. The speaker film 230 changes the electric sound signal into a mechanical vibration to generate a sound.

The vibration improving layer 220 is interposed between the reflective-transmissive polarizing film 210 and the speaker film 230 to improve sound quality of the sound.

The lower polarizing member 201 may have substantially the same material as the reflective-transmissive polarizing film 210. For example, the lower polarizing member 201 may include a phase difference layer such as phase difference layer 212 to change a linearly polarized light into a right or left circularly polarized light. Alternatively, the lower polarizing member 201 may also change the right or left circularly polarized light into the linearly polarized light.

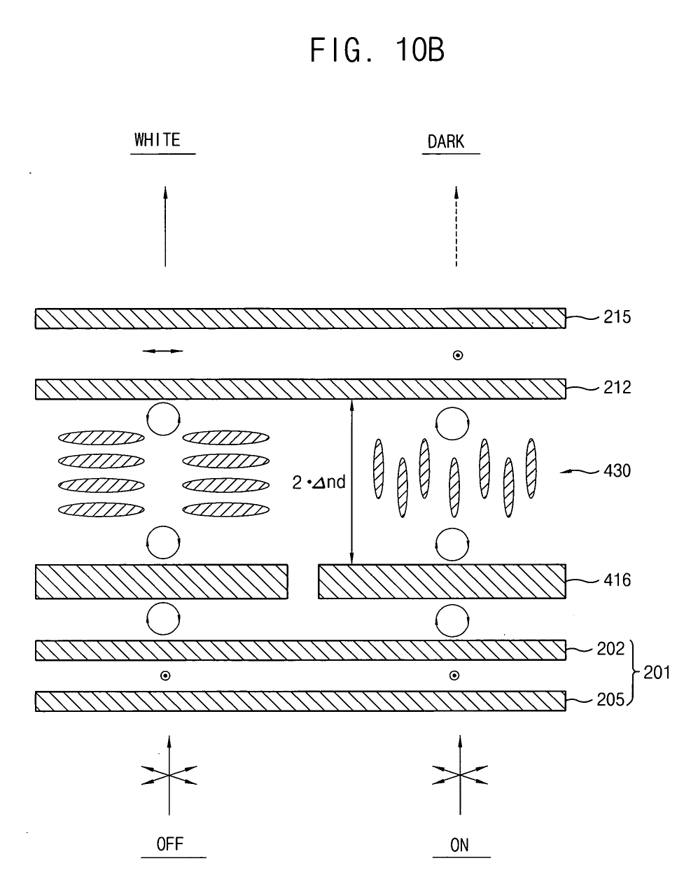

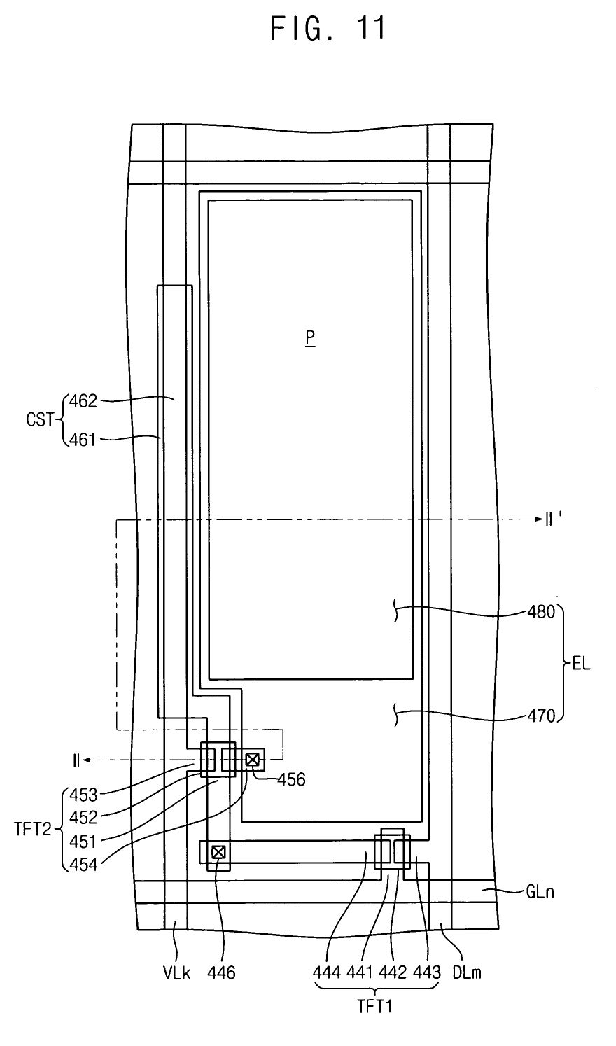

FIGS. 10A and 10B are cross-sectional views illustrating a light passing through the exemplary display panel module shown in FIG. 8. The display panel module has a normally white mode. In the normally white mode, the display panel module displays a white image when an electric power is not applied to a liquid crystal layer 430. In addition, the polarizing film assembly 200 serving as the upper polarizing member includes, in part, a first polarization layer 215 and a first phase difference layer 212. The lower polarizing member 201, as shown in FIG. 10B, includes, in part, a second polarization layer 205 and a second phase difference layer 202.

Referring to FIGS. 8 to 10A, in a reflection mode, corresponding to a reflection region RA, when the electric power is not applied to the liquid crystal layer 430, an externally provided light passes through the first polarization layer 215 to be a linearly polarized light. The linearly polarized light passes through the first phase difference layer 212 to be, for example, a left circularly polarized light. Alternatively, the linearly polarized light may pass through the first phase difference layer 212 to be a right circularly polarized light. That is, the first phase difference layer 212 changes a phase of the light by about λ/4.

When the left circularly polarized light passes through the liquid crystal layer 430, the liquid crystal layer 430 maintains a horizontal arrangement because the electric power is not applied to a liquid crystal, as shown in the OFF mode of FIG. 10A. The liquid crystal layer 430 having the horizontal arrangement changes the left circularly polarized light into a linearly polarized light. That is, the liquid crystal layer 430 changes a phase of the light by about λ/4. The linearly polarized light is reflected from the reflection electrode 417. The reflected linearly polarized light passes through the liquid crystal layer 430 again to be a left circularly polarized light. The liquid crystal layer 430 changes a phase of the light by about λ/4. Optical characteristics of the liquid crystal layer 430 corresponding to the reflection region RA are about Δnd, representing the second cell gap.

The left circularly polarized light passes through the first phase difference layer 212 to be a linearly polarized light that vibrates in a direction substantially parallel with a first polarizing direction of the first polarization layer 215. The linearly polarized light passes through the first polarization layer 215, thereby displaying a white image.

In the reflection mode, when the electric power is applied to the liquid crystal layer 430, as demonstrated by the ON mode of FIG. 10A, the externally provided light passes through the first polarization layer 215 to be the linearly polarized light. The linearly polarized light passes through the first phase difference layer 212 to be, for example, the left circularly polarized light. That is, the phase difference layer 212 changes a phase of the light by about λ/4.

The left circularly polarized light passes through the liquid crystal layer 430 that is vertically aligned by an electric power applied to a liquid crystal, so that the left circularly polarized light exits the liquid crystal layer 430. That is, the liquid crystal layer 430 does not change the phase of the light and lets the left circularly polarized light pass through the liquid crystal layer 430. The left circularly polarized light is reflected from the reflection electrode 417 to be a right circularly polarized light. The reflected right polarized light passes through the liquid crystal layer 430. The right circularly polarized light then passes through the first phase difference layer 212 to be a linearly polarized light vibrating in a direction substantially perpendicular to the first polarizing direction. The linearly polarized light is blocked by the first polarization layer 215, thereby displaying a black image.

Referring to FIGS. 8, 9 and 10B, in a transmission mode, corresponding to a transmission region TA, when the electric power is not applied to the liquid crystal layer 430, as demonstrated by the OFF mode in FIG. 10B, an internally provided light that is generated from a backlight assembly (not shown) passes through the second polarization layer 205 to be a linearly polarized light. The linearly polarized light passes through the second phase difference layer 202 to be a right circularly polarized light. That is, the second phase difference layer 202 changes a phase of the light by about λ/4. The right circularly polarized light passes through a pixel electrode 416 to be incident into the liquid crystal layer 430.

Optical characteristics of the liquid crystal layer 430 corresponding to the transmission region TA are about 2Δnd, representing a first cell gap, that is about twice the optical characteristics of the liquid crystal layer 430 corresponding to the reflection region RA.

When the electric power is not applied to the liquid crystal layer 430, the liquid crystal layer 430 is horizontally aligned. The right circularly polarized light passes through the liquid crystal layer 430 to be a left circularly polarized light. That is, the liquid crystal layer 430 changes a phase of the light by about λ/2. The left circularly polarized light passes through the first phase difference layer 212 to be a linearly polarized light that vibrates substantially in the first polarizing direction of the first polarization layer 215. The linearly polarized light passes through the first polarization layer 215, thereby displaying a white image.

In the transmission mode, when the electric power is applied to the liquid crystal layer 430, as demonstrated by the ON mode in FIG. 10B, the internally provided light from the backlight assembly (not shown) passes through the second polarization layer 205 to be a linearly polarized light. The linearly polarized light passes through the second phase difference layer 202 to be a right circularly polarized light. The right circularly polarized light passes through the pixel electrode 416 to be incident into the liquid crystal layer 430.

When the electric power is applied to the liquid crystal layer 430, the liquid crystal layer 430 is vertically aligned. The right circularly polarized light passes through the liquid crystal layer 430, so that the right circularly polarized light exits the liquid crystal layer 430. That is, the liquid crystal layer 430 does not change a phase of the light.

The right circularly polarized light passes through the first phase difference layer 212 to be a linearly polarized light that vibrates substantially perpendicular to the first polarizing direction of the first polarization layer 215. The linearly polarized light is blocked by the first polarization layer 215, thereby displaying a black image.

In FIGS. 8 to 10B, the display panel module is a reflective-transmissive type. Alternatively, the display panel module may be a transmissive type. In FIGS. 8 to 10B, the polarizing film assembly 200 serving as the upper polarizing member includes the speaker film 230. Alternatively, the lower polarizing member 201 may include the speaker film 230.

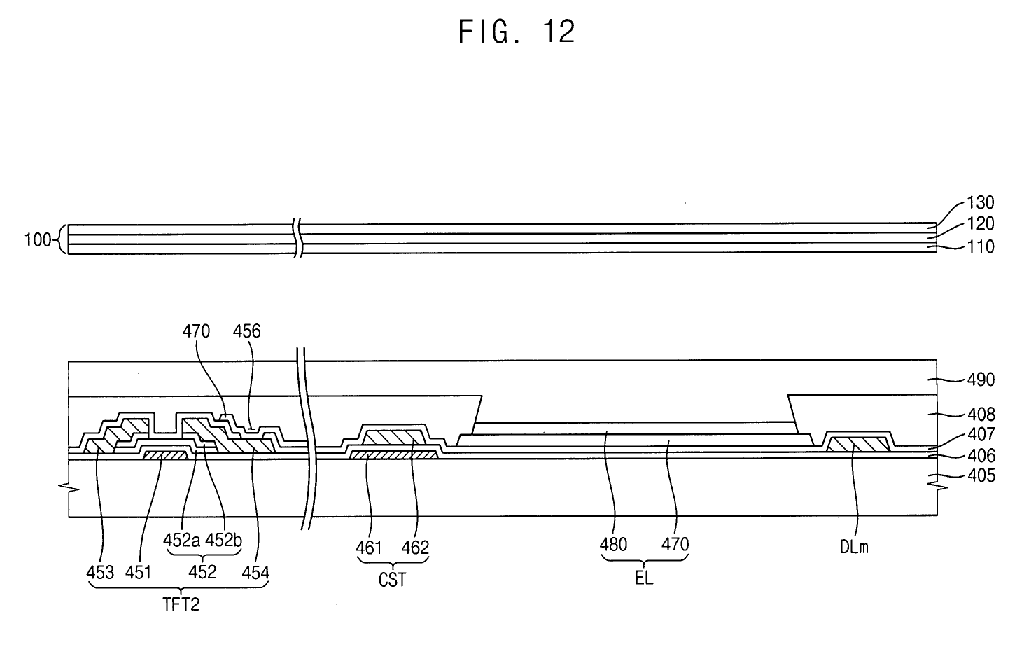

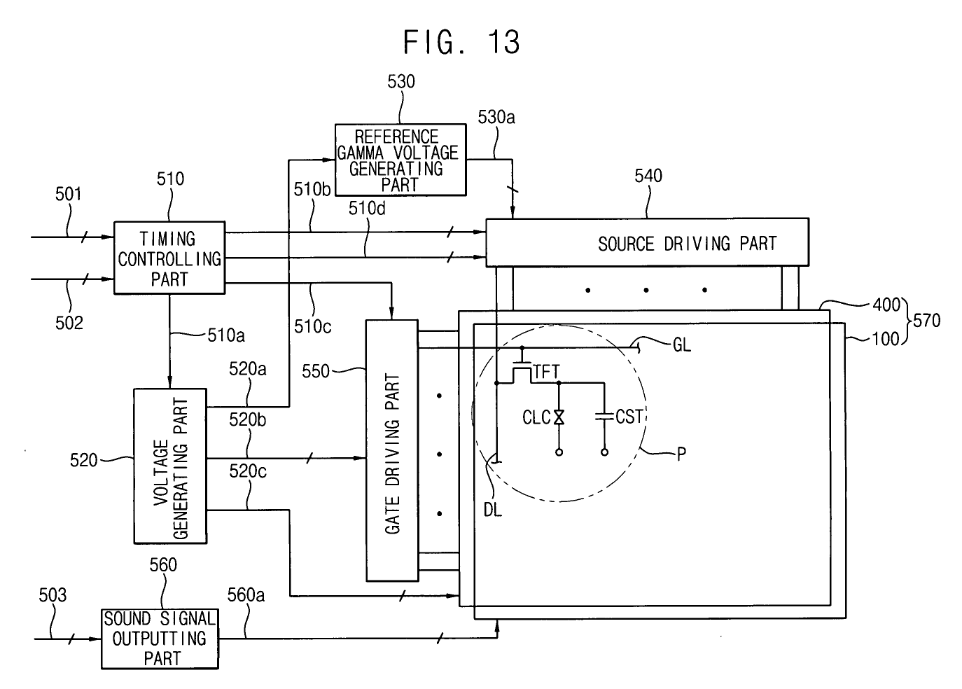

FIG. 11 is a plan view illustrating an exemplary display panel module in accordance with another exemplary embodiment of the present invention. FIG. 12 is a cross-sectional view taken along line II-II′ shown in FIG. 11.

Referring to FIGS. 11 and 12, the display panel module includes an organic light-emitting display (“OLED”) panel and a polarizing film assembly 100 that is on the OLED panel.

The OLED panel includes a base substrate 405. The base substrate 405 includes a plurality of source lines DLm, a plurality of gate lines GLn, a plurality of bias voltage lines VLk, and a plurality of pixels P. The pixels P are defined by the source, gate and bias voltage lines DLm, GLn, and VLk.

Each of the pixels P includes a first switching element TFT1, a second switching element TFT2, a storage capacitor CST, and an organic light-emitting element EL.

The first switching element TFT1 includes a first gate electrode 441, a first source electrode 443, and a first drain electrode 444. The first gate electrode 441 is electrically connected to one of the gate lines GLn. The first source electrode 443 is electrically connected to one of the source lines DLm. The first drain electrode 444 is electrically connected to the storage capacitor CST and the second switching element TFT2. In addition, the first switching element TFT1 may further include a first channel portion 442 that is on the first gate electrode 441 between the first source electrode 443 and the first drain electrode 444. The first channel portion 442 may include an amorphous silicon layer and an N+ amorphous silicon layer (not shown).

The second switching element TFT2 includes a second gate electrode 451, a second source electrode 453, and a second drain electrode 454. The second gate electrode 451 is electrically connected to the first drain electrode 444 of the first switching element TFT1. The second source electrode 453 is electrically connected to one of the bias voltage lines VLk. The second drain electrode 454 is electrically connected to the organic light-emitting element EL. In addition, the second switching element TFT2 may further include a second channel portion 452 that is on the second gate electrode 451 between the second source electrode 453 and the second drain electrode 454. The second channel portion 452 may include an amorphous silicon layer 452a and an N+ amorphous silicon layer 452b. Impurities may be implanted on the upper portion of the amorphous silicon layer 452a to form the N+ amorphous silicon layer 412b. The second switching element TFT2 may be a driving element that drives the organic light-emitting element EL.

The storage capacitor CST includes a first electrode 461 and a second electrode 462. The first electrode 461 is electrically connected to the second gate electrode 451. The second electrode 462 is electrically connected to the bias voltage line VLk.

The organic light-emitting element EL includes a pixel electrode 470, a common electrode 490 (shown in FIG. 12) and an organic light-emitting layer 480. The pixel electrode 470 is electrically connected to the second drain electrode 454 through an opening 456 formed in a passivation layer 407. The organic light-emitting layer 480 is interposed between the pixel electrode 470 and the common electrode 490.

A gate insulating layer 406 is interposed between the first and second gate electrodes 441 and 451 and the first and second channel portions 442 and 452. The gate insulating layer 406 is further formed on exposed portions of the base substrate 405, as well as on the gate lines GLn and on the first electrodes 461 of the storage capacitor CST. A passivation layer 407 is formed on the first and second source electrodes 443 and 453 and the first and second drain electrodes 444 and 454. The passivation layer 407 is further formed on exposed portions of the gate insulating layer 406, as well as on the data lines DLm and the second electrode 462 of the storage capacitor.

The pixel electrode 470 of the organic light-emitting element EL is formed on the base substrate 405 having the gate insulating layer 406 and the passivation layer 407. The organic light-emitting layer 480 is formed on the pixel electrode 470. The common electrode 490 is formed on the organic light-emitting layer 480, and may be further formed on a bank layer 408. The pixel electrode 470 may be an anode of the organic light-emitting element EL. The common electrode 490 may be a cathode of the organic light-emitting element EL.

The organic light-emitting layer 480 may include a positive charge injecting layer, a positive charge transporting layer, a light-emitting layer, a negative charge injecting layer and a negative charge transporting layer in a luminous area defined by a bank layer 408 on the pixel electrode 470. The bank layer 408 may be formed from a negative typed photoresist layer, and an inner surface of the bank layer 408 may be inclined with respect to a surface of the base substrate 405.

In operation, a gate signal is applied to the first gate electrode 441 of the first switching element TFT1 through one of the gate lines GLn, thus turning on the first switching element TFT1. Then, a data signal is applied to the second switching transistor TFT2 through one of the source lines DLm. Therefore, the second switching element TFT2 is turned on, and the data signal is stored in the storage capacitor CST.

When the second switching element TFT2 is turned on, the data signal is applied to the organic light-emitting element EL based on a bias voltage that is transmitted through one of the bias voltage lines VLk. Therefore, the organic light-emitting element EL generates a light.

The polarizing film assembly 100 of FIGS. 11 and 12 is substantially the same as in FIG. 1, and reference should be made to FIG. 1 for a more detailed view of the polarizing film assembly 100 of the display panel module of FIGS. 11 and 12. Thus, the same reference numerals will be used to refer to the same or like parts as those described in FIG. 1 and any further explanation concerning the above elements will be omitted.

Referring again to FIG. 1, the polarizing film assembly 100 includes a transmissive polarizing film 110, a vibration improving layer 120, a speaker film 130, a protecting film 140, and line members 151 and 152. The transmissive polarizing film 110 transmits a component of a light vibrating parallel to a polarizing direction, and blocks a component of the light vibrating perpendicular to the polarizing direction.

A sound signal is applied to the line members 151 and 152 that are electrically connected between the speaker film 130 and an output terminal of a sound signal outputting part (not shown). The speaker film 130 changes the sound signal into a mechanical vibration to generate a sound.

The vibration improving layer 120 is interposed between the transmissive polarizing film 110 and the speaker film 130 and improves the vibration of the speaker film 130, thereby improving a sound quality.

FIG. 13 is a block diagram illustrating an exemplary display device in accordance with another exemplary embodiment of the present invention.

Referring to FIG. 13, the display device includes a timing controlling part 510, a voltage generating part 520, a reference gamma voltage generating part 530, a sound signal outputting part 560, and a display part 570.

The timing controlling part 510 generates a first control signal 510a, a second control signal 510b, and a third control signal 510c based on an externally provided control signal 501 from an external unit (not shown). The first control signal 510a controls the voltage generating part 520. The second control signal 510b controls the source driving part 540. The third control signal 510c controls the gate driving part 550.

The externally provided control signal 501 may include a main clock signal MCLK, a horizontal synchronizing signal HSYNC, a vertical synchronizing signal VSYNC, a data enable signal DE, etc. The first control signal 510a includes the main clock signal MCLK. The second control signal 510b includes a horizontal start signal STH and a load signal TP. The third control signal 510c includes a start signal STV, a scan clock signal CPV, and an output enable signal OE.

The timing controlling part 510 processes a first data signal 502 from the externally provided unit through an interface method to apply a second data signal 510d to the source driving part 540.

The voltage generating part 520 generates driving voltages to drive the display device. In particular, the voltage generating part 520 generates a power supply voltage 520a, a gate voltage 520b, and a common voltage 520c. The power supply voltage 520a is applied to the reference gamma voltage generating part 530. The gate voltage 520b is applied to the gate driving part 550. The common voltage 520c is applied to the display part 570. The gate voltage 520b includes a gate on voltage and a gate off voltage. The common voltage 520c includes a common voltage VCOM for a liquid crystal capacitor CLC and a common voltage VST for a storage capacitor CST.

The reference gamma voltage generating part 530 includes a resistor string having a plurality of resistors corresponding to a predetermined gamma curve. The power supply voltage 520a generated from the voltage generating part 520 is divided into a plurality of reference gamma voltages 530a using the resistor string to apply the reference gamma voltages 530a to the source driving part 540.

The source driving part 540 converts the second data signal 510d into a third data signal of an analog type based on the second control signal 510b and the reference gamma voltages 530a, and applies the third data signal of the analog type to the source lines DL of the display part 570.

The gate driving part 550 is a shift register that applies a plurality of gate signals to the gate lines GL of the display part 570 based on the third control signal 510c and the gate voltage 520b, in sequence. The gate driving part 550 may be integrated on the display part 570. Alternatively, the gate driving part 550 may be mounted on the display part 570.

The sound signal outputting part 560 applies a second sound signal 560a to the polarizing film assembly 100 of the display part 570 based on a first sound signal 503 provided from an external unit to the sound signal outputting part 560. In particular, the second sound signal 560a is applied to two end portions of a speaker film 130 of the polarizing film assembly 100.

The display part 570 includes an LCD panel 400 and the polarizing film assembly 100 that is on the LCD panel 400.

The LCD panel 400 includes the source lines DL, the gate lines GL, and a plurality of pixels P arranged in a matrix. The pixels P are defined by the source and gate lines DL and GL. Each of the pixels P includes a switching element TFT, such as a thin film transistor, a liquid crystal capacitor CLC and a storage capacitor CST.

The polarizing film assembly 100 includes a transmissive polarizing film 110, a vibration improving layer 120, a speaker film 130, a protecting film 140, and line members 151 and 152.

The transmissive polarizing film 110 includes a PSA layer 111, a first protection layer 112, a polarization layer 113, and a second protection layer 114. Each of the first and second protection layers 112 and 114 may include TAC. The polarization layer 113 may include polyvinylalcohol PVA. The first protection layer 112 is interposed between the PSA layer 111 and the polarization layer 113. The second protection layer 114 is formed on the polarization layer 113 opposite to the first protection layer 112.

The polarization layer 113 transmits a portion of a light vibrating in a polarization direction, and blocks a remaining portion of the light vibrating in a different direction from the polarization direction. The vibration improving layer 120 is formed on the second protection layer 114. The vibration improving layer 120 may include an air layer. Alternatively, the vibration improving layer 120 may include an elastic material.

The speaker film 130 includes a piezoelectric layer 131 disposed between a first electrode 132 and a second electrode 133. The first electrode 132 is formed on a first surface of the piezoelectric layer 131, where the first electrode 132 is disposed between the vibration improving layer 120 and the piezoelectric layer 131. The second electrode 133 is formed on a second surface of the piezoelectric layer 131, opposite the first surface, where the second electrode 133 is disposed between the protecting film 140 and the piezoelectric layer 131. The first electrode 132 may be substantially plate-shaped and may cover substantially an entire surface area of the first surface of the piezoelectric layer 131. Likewise, the second electrode 133 may be substantially plate-shaped and may cover substantially an entire surface area of the second surface of the piezoelectric layer 131. The first and second electrodes 132 and 133 are electrically connected to the first and second lines 151 and 152, respectively. The second sound signal 560a is applied to the speaker film 130 through the first and second lines 151 and 152.

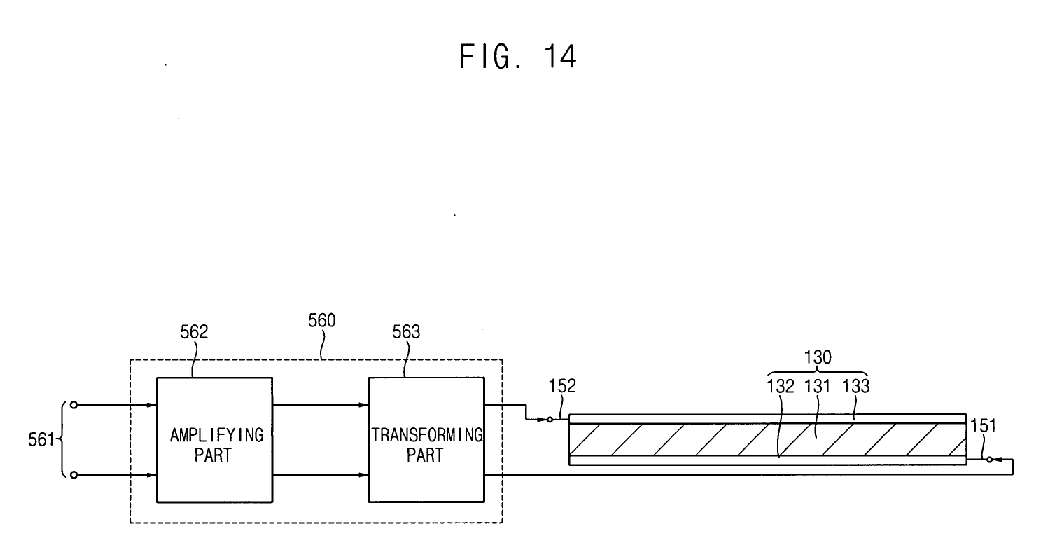

FIG. 14 is a block diagram illustrating an exemplary sound signal outputting part shown in FIG. 13.

Referring to FIGS. 1, 13 and 14, the sound signal outputting part 560 includes an input part 561, an amplifying part 562 and a transforming part 563. The transforming part 563 applies a second sound signal 560a to the first and second lines 151 and 152 that are electrically connected to the first and second electrodes 132 and 133, respectively, of the speaker film 130.

The input part 561 receives the first sound signal 503 that is provided from an exterior source to the sound signal outputting part 560. The amplifying part 562 amplifies a level of the first sound signal 503. The transforming part 563 outputs the second sound signal 560a based on the amplified first sound signal 503. In particular, the second sound signal 560a drives the speaker film 130.

The second sound signal 560a is applied to the first and second electrodes 132 and 133 through the first and second lines 151 and 152, respectively, that are electrically connected to output terminals of the transforming part 563.

When the second sound signal 560a is applied to the first and second electrodes 132 and 133, the piezoelectric layer 131 vibrates to generate a sound.

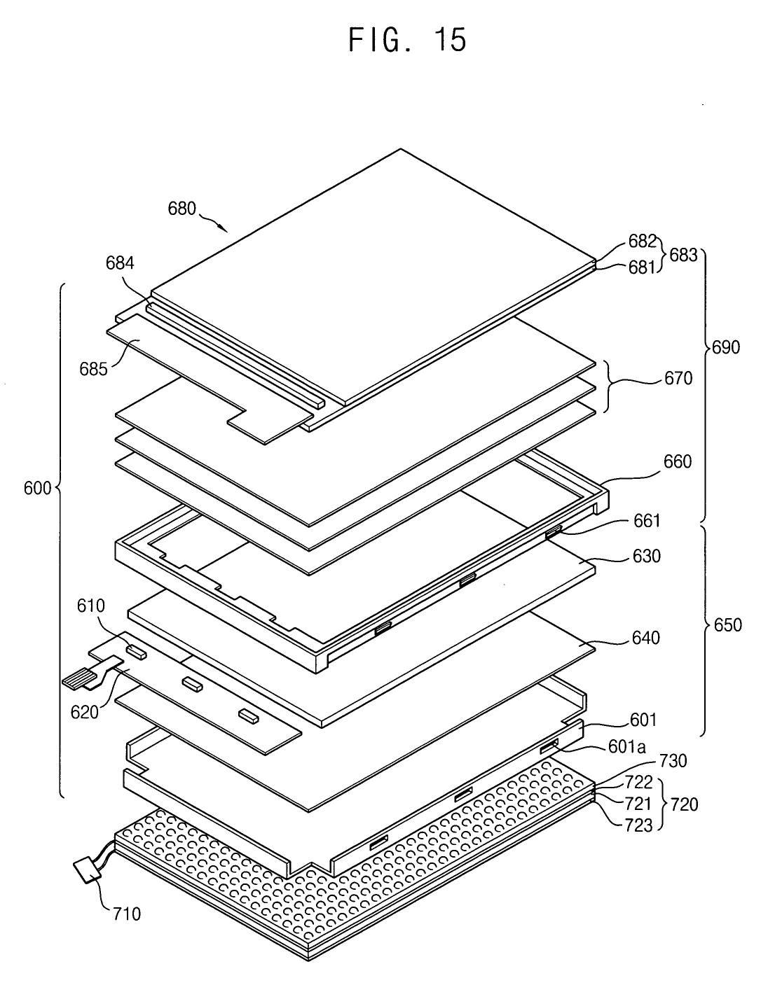

FIG. 15 is an exploded perspective view illustrating an exemplary display device in accordance with another exemplary embodiment of the present invention.

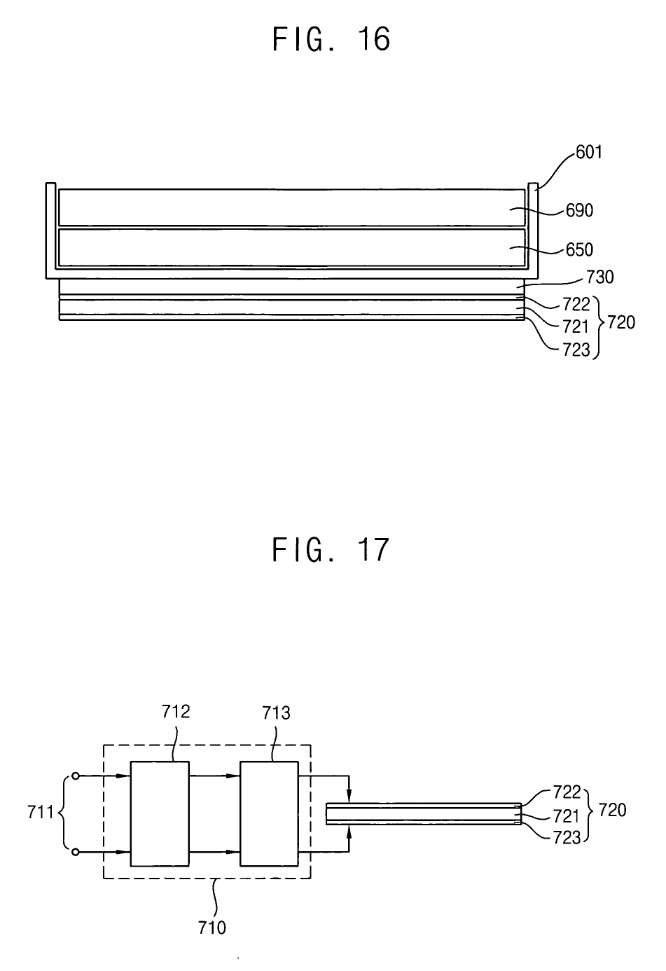

FIG. 16 is a cross-sectional view illustrating the exemplary display device shown in FIG. 15.

Referring to FIGS. 15 and 16, the display device includes a display assembly 600, a sound signal outputting part 710, a speaker film 720, and a vibration improving layer 730.

The display assembly 600 includes a receiving container 601, a backlight assembly 650, and a panel assembly 690.

The receiving container 601 includes a bottom plate and a plurality of sidewalls that are protruded from sides of the bottom plate to form a receiving space. A fixing hole 601a is formed on at least one of the sidewalls of the receiving container 601.

The backlight assembly 650 generates a light. The backlight assembly 650 includes a light source 610, a flexible printed circuit board (“PCB”) 620, a light guiding plate 630, and a reflecting plate 640.

The light source 610 generates a light. For example, the light source 610 may include a plurality of light-emitting diodes (“LED”), although other light sources would be within the scope of these embodiments. The light source 610 may be on a side of the light guiding plate 630. Alternatively, the light source 610 may be under the light guiding plate 630. While illustrated on one side of the light guiding plate 630, the light source 610 may be on opposing sides of the light guiding plate 630.

The light source 610 may be mounted on the flexible PCB 620. The flexible PCB 620 includes a circuit pattern to transmit a driving signal to the light source 610. Alternatively, the light source 610 may be spaced apart from the flexible PCB 620.

The light guiding plate 630 guides the light generated from the light source 610. The light guiding plate 630 may include a plurality of dot patterns (not shown) to guide the light. The dot patterns may be printed on the light guiding plate 630. Alternatively, the light guiding plate 630 may be pressed using a mold to form the dot patterns. Other patterns such as ridges and grooves may alternatively or additionally be formed on the light guiding plate 630.

A portion of the light leaked from the light guiding plate 630 is reflected by the reflecting plate 640, positioned below the light guiding plate 630, to reflect the light back toward the light guiding plate 630 to increase a luminance of the backlight assembly 650. The reflecting plate 640 may have a plate shape, a sheet shape, etc.

The panel assembly 690 is on the backlight assembly 650 to display images based on the light. The panel assembly 690 includes a mold frame 660, a luminance increasing part 670, and a display panel module 680.

The mold frame 660 receives the luminance increasing part 670, and guides the flexible PCB 620 and the light guiding plate 630. A fixing protrusion 661 is formed on at least one of sidewalls of the mold frame 660.

The fixing protrusion 661 is inserted into the fixing hole 601a of the receiving container 601, so that the mold frame 660 is combined with the receiving container 601. Therefore, the backlight assembly 650 is fixed to the receiving container 601.

The luminance increasing part 670 includes a diffusion member and a plurality of optical sheets. Any number of optical sheets may be used. The luminance increasing part 670 is received in the mold frame 660. The luminance increasing part 670 increases a luminance uniformity and a luminance when viewed on a plane. The light exiting the luminance increasing part 670 is incident into the display panel module 680.

The display panel module 680 displays images using electrical and optical characteristics of liquid crystal molecules. The display panel module 680 includes a display panel 683, a driving chip 684 and a flexible PCB 685.

The display panel 683 includes a thin film transistor (“TFT”) substrate 681, a color filter substrate 682, and a liquid crystal layer (not shown) containing the liquid crystal molecules. The color filter substrate 682 faces the TFT substrate 681, and is combined with the TFT substrate 681. The liquid crystal layer (not shown) is interposed between the TFT substrate 681 and the color filter substrate 682.

The driving chip 684 is mounted on a peripheral portion of the TFT substrate 681 to apply driving signals to the display panel 683. The driving signals include a data signal, a gate control signal, and a data control signal. The driving chip 684 may include a data driving chip and a gate driving chip. Alternatively, the driving chip 684 may include a single integrated driving chip. For example, the driving chip 684 is mounted on the peripheral portion of the TFT substrate 681 through a chip on glass (“COG”) method, although other methods of combining the driving chip 684 with the TFT substrate 681 are within the scope of these embodiments.

The flexible PCB 685 is mounted on the peripheral portion of the TFT substrate 681 to apply externally provided signals to the driving chip 684. The flexible PCB 685 may be electrically connected to the TFT substrate 681 through an anisotropy conductive film (“ACF”).

The sound signal outputting part 710 applies a second sound signal to a speaker film 720 based on a first sound signal provided from an exterior source to the sound signal outputting part 710.

The speaker film 720 is disposed under the receiving container 601, such as under the bottom plate of the receiving container 601. The speaker film 720 includes a piezoelectric layer 721 disposed between a first electrode 722 and a second electrode 723. The first electrode 722 is formed on a first surface of the piezoelectric layer 721. The second electrode 723 is formed on a second surface of the piezoelectric layer 721. The first electrode 722 may be substantially plate-shaped and may cover substantially an entire surface area of the first surface of the piezoelectric layer 721. Likewise, the second electrode 723 may be substantially plate-shaped and may cover substantially an entire surface area of the second surface of the piezoelectric layer 721.

The piezoelectric layer 721 changes the second sound signal that is an electric signal from the sound signal outputting part 710 into a mechanical vibration to generate a sound. The piezoelectric layer 721 may include PVDF or derivatives thereof. Alternatively, the piezoelectric layer 721 may include a mixture of PVDF and HFP, a copolymer of VDF/TrFE, etc.

When the second sound signal that is generated from the sound signal outputting part 710 is applied to the first and second electrodes 722 and 723, the piezoelectric layer 721 vibrates to generate a sound. Each of the first and second electrodes 722 and 723 may include a metal or a transparent conductive material. The first and second electrodes 722 and 723 are on two opposite surfaces of the piezoelectric layer 721.

The vibration improving layer 730 includes at least one of an air layer, a bubble layer having a plurality of air bubbles, an embossing layer, an elastic transparent adhesive layer, etc., to increase the vibration of the speaker film 720.

The vibration improving layer 730 is interposed between one surface of the receiving container 601, such as the bottom plate, and a first surface of the speaker film 720 that corresponds to the one surface of the receiving container 601. For example, the vibration improving layer 730 may be disposed between the bottom plate of the receiving container 601 and the first electrode 722 of the speaker film 720.

The vibration improving layer 730 increases the vibration of the first surface of the speaker film 720. An air layer may be on a second surface of the speaker film 720 to increase the vibration of the piezoelectric layer 721.

FIG. 17 is a block diagram illustrating an exemplary operation of an exemplary speaker film shown in FIG. 15.

Referring to FIG. 17, the sound signal outputting part 710 includes an input part 711, an amplifying part 712, and a transforming part 713. The transforming part 713 applies a second sound signal to the first and second electrodes 722 and 723 of the speaker film 720.

The input part 711 receives a first sound signal provided from an exterior source to the sound signal outputting part 710. The amplifying part 712 amplifies a level of the first sound signal. The transforming part 713 outputs the second sound signal based on the amplified first sound signal. In particular, the second sound signal drives the speaker film 720.

The second sound signal that is outputted from output terminals of the transforming part 713 is applied to the first and second electrodes 722 and 723. The output terminals of the transforming part 713 are electrically connected to the first and second electrodes 722 and 723, respectively.

When the second sound signal is applied to the first and second electrodes 722 and 723, the piezoelectric layer 721 of the speaker film 720 vibrates to generate the sound.

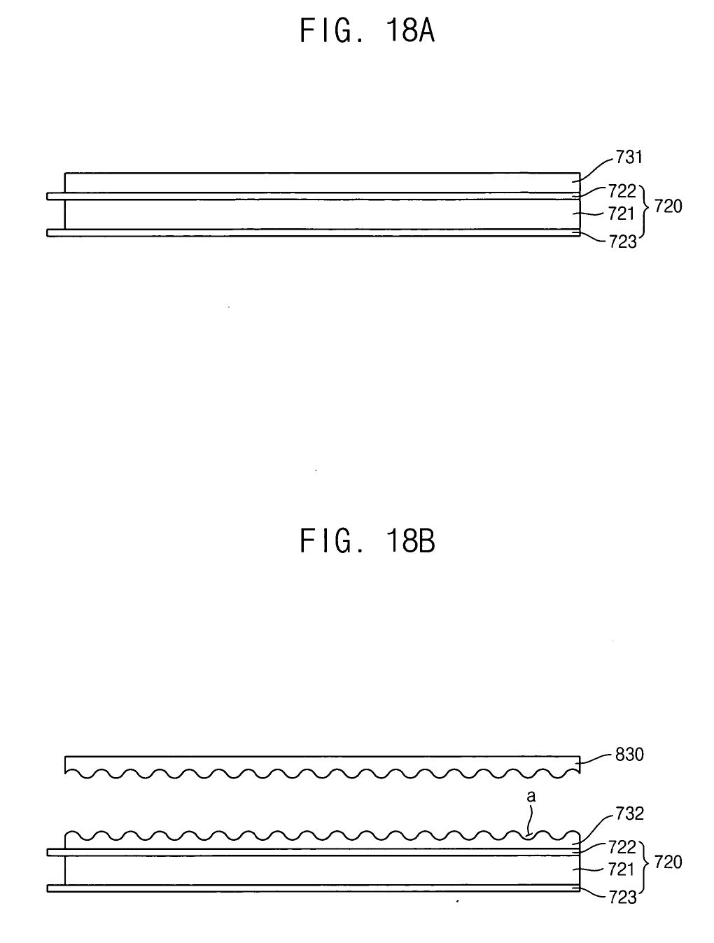

FIGS. 18A and 18B are cross-sectional views illustrating an exemplary process of forming an exemplary vibration improving layer shown in FIG. 15.

Referring to FIGS. 18A and 18B, a synthetic resin layer 731 is coated on a first electrode 722 of the speaker film 720.

The synthetic resin layer 731 is pressed using a mold 830 having an embossing pattern to form the vibration improving layer 732 having the embossing pattern.

The synthetic resin layer 731 includes an acryl based ultraviolet curable resin. Examples of the acryl based ultraviolet curable resin that can be used for the synthetic resin layer 731 include, but are not limited to, a photopolymerization monomer or oligomer having an acrylate, an epoxyacrylate, polyester acrylate, urethane acrylate, etc., acetophenone, benzophenone, thioxanthone, etc. These can be used alone or in a combination thereof.

Therefore, the vibration improving layer 732 has a plurality of convexes and a plurality of concaves. An air layer is formed in the concaves, as indicated by the reference character “a” in FIG. 18B.

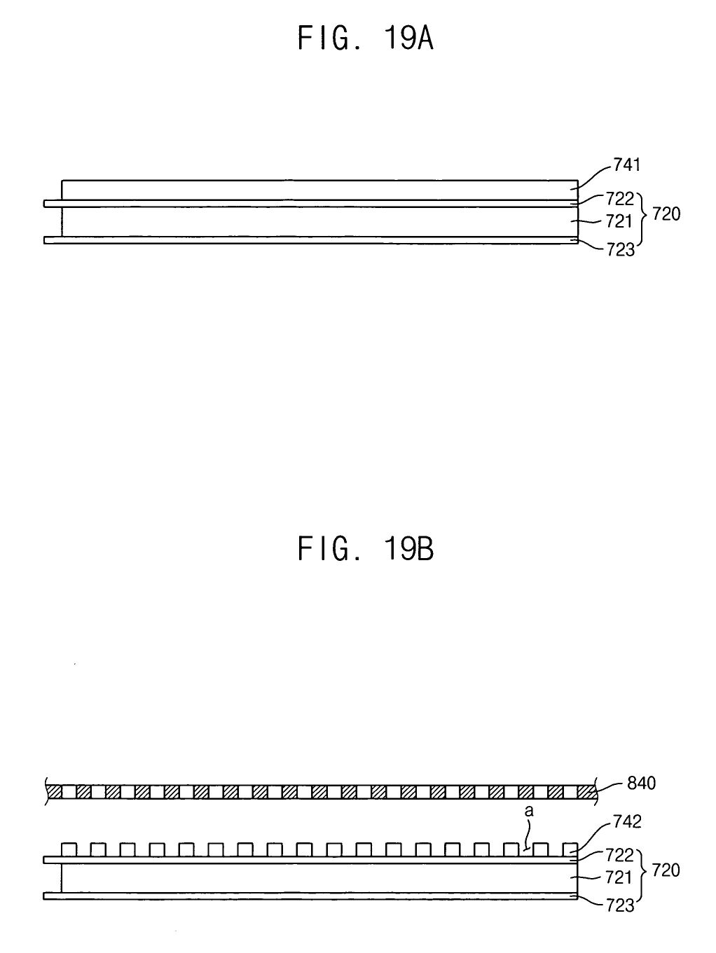

FIGS. 19A and 19B are cross-sectional views illustrating an exemplary process of forming an exemplary vibration improving layer in accordance with another exemplary embodiment of the present invention.

Referring to FIGS. 19A and 19B, a synthetic resin layer 741 is coated on a first electrode 722 of the speaker film 720. The synthetic resin layer 741 is patterned using a mask 840 having opening patterns to partially remove the synthetic resin layer 741.

The vibration improving layer 742 includes a plurality of convexes and a plurality of concaves. A portion of a synthetic resin of the synthetic resin layer 741 may remain in the vibration improving layer 742 to form the convexes, and the synthetic resin of the synthetic resin layer 741 is removed from the vibrating layer 742 to form the concaves. An air layer is formed in the concaves, as indicated by the reference character “a” in FIG. 19B.

The synthetic resin layer 741 includes an acryl based ultraviolet curable resin. Examples of the acryl based ultraviolet curable resin that can be used for the synthetic resin layer 741 include, but are not limited to, a photopolymerization monomer or oligomer having an acrylate, an epoxyacrylate, polyester acrylate, urethane acrylate, etc., acetophenone, benzophenone, thioxanthone, etc. These can be used alone or in a combination thereof.

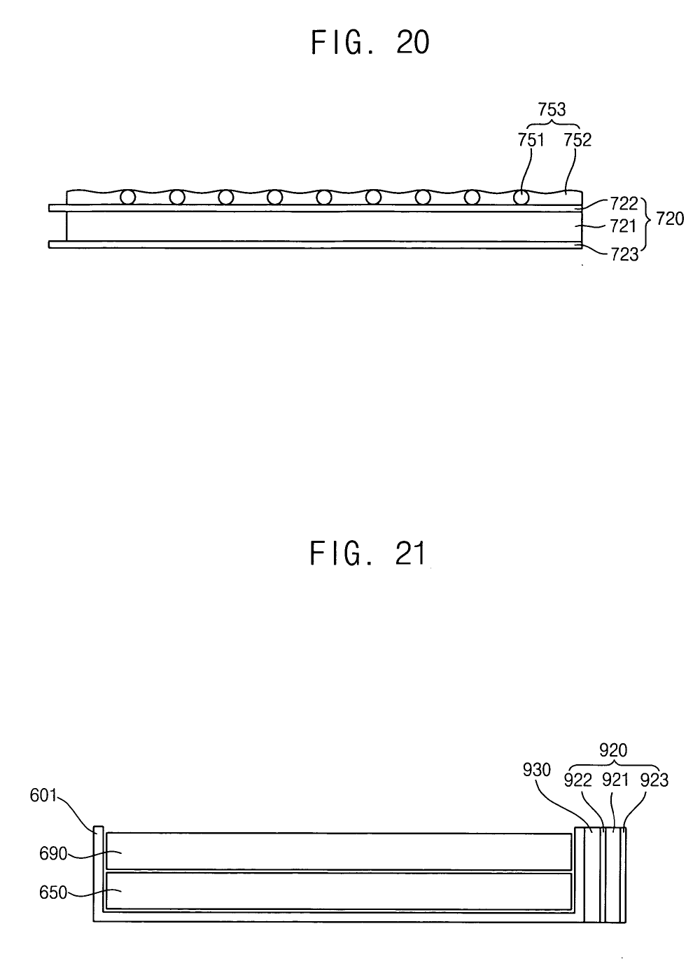

FIG. 20 is a cross-sectional view illustrating an exemplary method of forming an exemplary vibration improving layer in accordance with another exemplary embodiment of the present invention.

Referring to FIG. 20, a mixture of transparent adhesives 752 and a plurality of spacers 751 is coated on a first electrode 722 of the speaker film 720 to form a vibration improving layer 753. The transparent adhesives 752 are an elastic material that may be synchronized with the vibration of the speaker film 720.

That is, the spacers 751 maintain a distance between a speaker film 720 and a display device. The transparent adhesives 752, which are an elastic material, increase a vibration of the speaker film 720.

FIG. 21 is a cross-sectional view illustrating an exemplary display device in accordance with another exemplary embodiment of the present invention. The display device of FIG. 21 is substantially the same as in FIG. 15 except for a speaker film 920 and a vibration improving layer 930. Thus, the same reference numerals will be used to refer to the same or like parts as those described in FIG. 15 and any further explanation concerning the above elements will be omitted.

Referring to FIG. 21, the display device includes a display assembly, a sound signal outputting part (not shown), a speaker film 920, and a vibration improving layer 930. The display assembly includes, in part, a receiving container 601, a backlight assembly 650, and a panel assembly 690.

The receiving container 601 includes a receiving space to receive the backlight assembly 650 and the panel assembly 690. The backlight assembly 650 generates a light toward the panel assembly 690. The panel assembly 690 displays an image based on the light.

The speaker film 920 is on a side surface of the receiving container 601. For example, the speaker film 920 is positioned adjacent one of the sidewalls of the receiving container 601, instead of below the bottom plate of the receiving container 601 as in previous embodiments described above.

The speaker film 920 includes a piezoelectric layer 921 disposed between a first electrode 922 and a second electrode 923. The first electrode 922 is formed on a first surface of the piezoelectric layer 921. The second electrode 923 is formed on a second surface of the piezoelectric layer 921. The first electrode 922 may be positioned closer to the sidewall of the receiving container 601 than the second electrode 923. The first and second electrodes 922, 923 may be substantially plate-shaped and may have substantially the same surface area as the piezoelectric layer 921.

The piezoelectric layer 921 changes a second sound signal that is outputted from the sound signal outputting part (not shown) into a mechanical vibration to generate a sound. The piezoelectric layer 921 may include, but is not limited to, PVDF or derivatives thereof.

When the second sound signal that is generated from the sound signal outputting part (not shown) is applied to the first and second electrodes 922 and 923, the piezoelectric layer 921 vibrates to generate the sound. Each of the first and second electrodes 922 and 923 may include a metal or a transparent conductive material. The first and second electrodes 922 and 923 are on first and second surfaces of the piezoelectric layer 921, respectively.

The vibration improving layer 930 includes at least one of an air layer, a bubble layer having a plurality of air bubbles, an embossing layer, an elastic transparent adhesive layer having spacers, etc., to increase a vibration of the speaker film 920. The vibration improving layer 930 is interposed between a side surface of the display device and the speaker film 920. In particular, the vibration improving layer 930 may be provided between a sidewall of the receiving container 601 and the first electrode 922 of the speaker film 920.

The vibration improving layer 930 increases a vibration of a first surface of the speaker film 920. An air layer may be on a second surface of the speaker film 920 to increase a vibration of the piezoelectric layer 921.

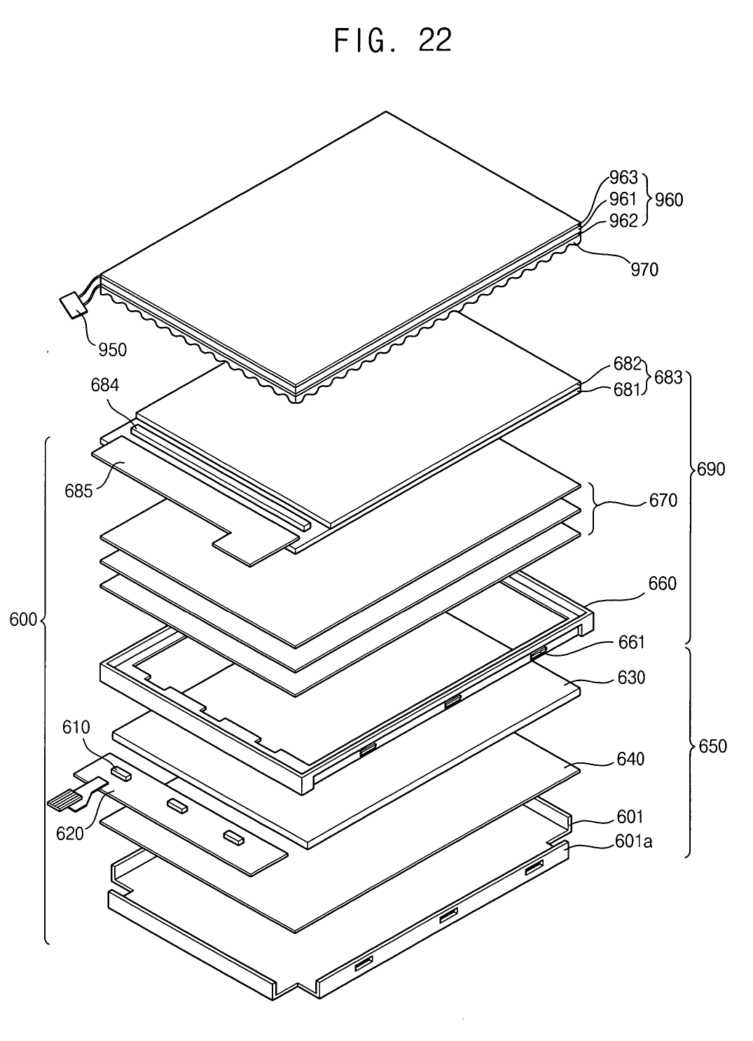

FIG. 22 is an exploded perspective view illustrating an exemplary display device in accordance with another exemplary embodiment of the present invention.

The display device of FIG. 22 is substantially the same as in FIG. 15 except for a speaker film and a vibration improving layer. Thus, the same reference numerals will be used to refer to the same or like parts as those described in FIG. 15 and any further explanation concerning the above elements will be omitted.

Referring to FIG. 22, the display device includes a display assembly 600, a sound signal outputting part 950, a speaker film 960, and a vibration improving layer 970. The display assembly 600 includes a receiving container 601, a backlight assembly 650, and a panel assembly 690.

The sound signal outputting part 950 applies a second sound signal to a speaker film 960 based on a first sound signal provided from an exterior source to the sound signal outputting part 950.

The speaker film 960 is on the display panel 683. The speaker film 960 includes a piezoelectric layer 961 disposed between a first electrode 962, and a second electrode 963. The first electrode 962 is formed on a first surface of the piezoelectric layer 961. The second electrode 963 is formed on a second surface of the piezoelectric layer 961. The first and second electrodes 962, 963 may be substantially plate-shaped and may have substantially the same surface area as the piezoelectric layer 961.

The piezoelectric layer 961 changes the second sound signal that is an electric signal from the sound signal outputting part 950 into a mechanical vibration to generate a sound. The piezoelectric layer 961 may include PVDF or derivatives thereof. Alternatively, the piezoelectric layer 961 may include, but is not limited to, a mixture of PVDF and HFP, a copolymer of VDF/TrFE, etc.

When the second sound signal that is generated from the sound signal outputting part 950 is applied to the first and second electrodes 962 and 963, the piezoelectric layer 961 vibrates to generate a sound. Each of the first and second electrodes 962 and 963 may include a transparent conductive material. Examples of the transparent conductive material that can be used for the first and second electrodes 962 and 963 include, but are not limited to, ITO, TO, IZO, ZO, ITZO, a-ITO, etc. These can be used alone or in a combination thereof.

The vibration improving layer 970 includes at least one of an air layer, a bubble layer having a plurality of air bubbles, an embossing layer, an elastic transparent adhesive layer, etc., to increase a vibration of the speaker film 960. The vibration improving layer 970 is interposed between one surface of the display panel 683 and a first surface of the speaker film 960 corresponding to the display panel 683. In particular, the vibration improving layer 970 may be disposed between the color filter substrate 682 of the display panel 683 and the first electrode 962 of the speaker film 960. For example, the vibration improving layer 970 comprises a transparent material.

The vibration improving layer 970 increases the vibration of a first surface of the speaker film 960. An air layer may be on a second surface of the speaker film 960 to increase the vibration of the speaker film 960.

According to the present invention, the polarizing member includes the speaker film so that the display device may generate the sound. The polarizing film is combined with the speaker film through the vibration improving layer that is interposed between the polarizing film and the speaker film to increase the vibration of the speaker film, thereby increasing the sound quality. Therefore, the size and thickness of the display device may be decreased.

In addition, the speaker film may be attached to the display panel assembly using the vibration improving layer so that the size and thickness of the display device are decreased. Furthermore, the amount of the sound and the sound quality are increased.

This invention has been described with reference to the exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A polarizing film assembly comprising:
a polarizing film including a polarization layer transmitting a component of a light vibrating parallel to a polarizing direction;
a speaker film on the polarizing film, the speaker film changing an electric signal into a mechanical vibration to generate a sound;
a vibration improving layer interposed between the polarizing film and the speaker film, the vibration improving layer improving the mechanical vibration; and
a line member electrically connected to the speaker film, the line member transmitting the electric signal.

2. The polarizing film assembly of claim 1, wherein the speaker film comprises:
first and second electrodes receiving the electric signal; and
a piezoelectric layer interposed between the first and second electrodes.

3. The polarizing film assembly of claim 2, wherein the first electrode covers at least a substantial portion of a first surface of the piezoelectric layer, and the second electrode covers at least a substantial portion of a second surface of the piezoelectric layer, the first surface opposite the second surface.

4. The polarizing film assembly of claim 2, further comprising:
a conductive part on an end portion of the vibration improving layer, the conductive part electrically connected to the first electrode of the speaker film; and
a protecting layer attached on the second electrode of the speaker film through a conductive adhesive.

5. The polarizing film assembly of claim 4, wherein the line member comprises:
a first line electrically connected to the conductive part; and
a second line electrically connected to the conductive adhesive.

6. The polarizing film assembly of claim 1, wherein the vibration improving layer comprises an air layer.

7. The polarizing film assembly of claim 6, wherein the vibration improving layer further comprises:
a convex portion supporting the speaker film and the polarizing film; and
a concave portion forming the air layer.

8. The polarizing film assembly of claim 1, wherein the vibration improving layer comprises:
a plurality of spacers; and
an elastic adhesive layer holding the spacers.

9. The polarizing film assembly of claim 1, wherein the vibration improving layer is formed of a synthetic resin layer.

10. The polarizing film assembly of claim 9, wherein the vibration improving layer includes a plurality of bubbles.

11. The polarizing film assembly of claim 1, wherein the polarizing film further comprises a phase difference layer under the polarization layer, the phase difference layer changing a phase of the light.

12. A method of manufacturing a polarizing film assembly, the method comprising:
forming a primary film having a polarization layer;
forming a vibration improving layer on the primary film;
attaching a speaker film to the vibration improving layer to form a first film assembly;
cutting the first film assembly with respect to a size of a display panel;
forming a conductive part electrically connected to a first electrode of the speaker film on an end portion of the vibration improving layer;
attaching a transparent protecting film having a transparent conductive adhesive layer to a second electrode of the speaker film; and
forming a first line electrically connected to the conductive part and a second line electrically connected to the transparent conductive adhesive layer.

13. The method of claim 12, wherein forming the vibration improving layer includes:
coating a synthetic resin layer on the primary film; and
pressing a mold having an embossing pattern onto the synthetic resin layer so that the vibration improving layer has the embossed pattern.

14. The method of claim 12, wherein forming the vibration improving layer includes:
coating a synthetic resin layer on the primary film; and
partially removing the synthetic resin layer so that the vibration improving layer has a plurality of concaves.

15. The method of claim 12, wherein forming the vibration improving layer includes:
coating a synthetic resin layer on the primary film; and
forming a plurality of bubbles in the synthetic resin layer.

16. The method of claim 12, wherein forming the vibration improving layer includes providing an elastic adhesive layer and a plurality of spacers in the elastic adhesive layer on the primary film.

17. The method of claim 12, wherein forming the conductive part includes injecting a conductive material on an end portion of the vibration improving layer.

18. The method of claim 12, wherein forming the vibration improving layer includes employing a transparent material.

19. The method of claim 12, wherein each of the first and second electrodes of the speaker film comprises a transparent conductive material.

20. A display device comprising:
a display panel having a source line, a gate line, and a switching element electrically connected to the source and gate lines;
a source driving part converting a first data signal into a second data signal of an analog type and applying the second data signal to the source line;
a gate driving part applying a gate signal to the gate line;
a sound signal outputting part receiving a first sound signal and generating a second sound signal based on the first sound signal; and
a polarizing member on the display panel, the polarizing member transmitting a component of a light vibrating parallel to a polarizing direction, the polarizing member generating a sound based on the second sound signal.

21. The display device of claim 20, wherein the polarizing member comprises:
a polarizing film including a polarization layer having the polarizing direction and transmitting the component of the light vibrating parallel to the polarizing direction;
a speaker film on the polarizing film, the speaker film changing the second sound signal into a mechanical vibration to generate the sound;
a vibration improving layer interposed between the polarizing film and the speaker film, the vibration improving layer improving the mechanical vibration; and
a line member electrically connected to the speaker film, the line member transmitting the second sound signal.

22. The display device of claim 21, wherein the sound signal outputting part comprises:
an input part receiving the first sound signal; and
a transforming part transforming the first sound signal into the second sound signal having various levels to apply the second sound signal to the line member.

23. The display device of claim 20, wherein the polarizing member further comprises a phase difference layer changing a phase of the light.

24. A display device comprising:
a display assembly including:
a backlight assembly generating a light;
a panel assembly displaying an image using the light; and
a receiving container receiving the backlight assembly and the panel assembly;
a speaker film on the display assembly, the speaker film generating a sound; and
a vibration improving layer interposed between the display assembly and the speaker film.

25. The display device of claim 24, wherein the vibration improving layer comprises an air layer.

26. The display device of claim 25, wherein the vibration improving layer comprises:
a convex portion supporting the display assembly and the speaker film; and
a concave portion forming the air layer.

27. The display device of claim 24, wherein the vibration improving layer comprises:
a plurality of spacers supporting the display assembly and the speaker film; and
an elastic adhesive layer holding the spacers.

28. The display device of claim 24, wherein the speaker film is on a bottom plate of the receiving container.

29. The display device of claim 24, wherein the speaker film is on a sidewall of the receiving container.

30. The display panel of claim 24, wherein the speaker film comprises:
first and second electrodes receiving the electric signal; and
a piezoelectric layer interposed between the first and second electrodes.

31. A display device comprising:
a display assembly including:
a backlight assembly generating a light;
a panel assembly displaying an image using the light; and
a receiving container receiving the backlight assembly and the panel assembly; and
a speaker film on a surface of the display assembly, the speaker film including a vibration improving layer facing a surface of the display assembly.
